(19) United States
(12) Patent Application Publication
(10) Pub. No.: US 2026/0072564 A1
(43) Pub. Date: Mar. 12, 2026

(54) MOVEMENT USER INTERFACE

(71) Applicant: Apple Inc., Cupertino, CA (US)

(72) Inventors: Lynne DEVINE, San Francisco, CA (US); Daamun MOHSENI, Campbell, CA (US); Christopher P. FOSS, San Francisco, CA (US); Kurt R. STIEHL, Los Gatos, CA (US); Clarisse MAZUIR, San Jose, CA (US); Jonathan IVE, Cupertino, CA (US); Matthew J. ALLEN, Menlo Park, CA (US); Kevin M. LYNCH, Woodside, CA (US); Alan C. DYE, San Francisco, CA (US); Xiaofeng TANG, Santa Clara, CA (US); Daniel De Rocha ROSARIO, San Francisco, CA (US); Ronak N. SHAH, Los Altos, CA (US); Tom HSU, Santa Clara, CA (US); Arian BEHZADI, San Francisco, CA (US); Andrew S. KIM, Walnut Creek, CA (US); Jean-Pierre M. MOUILLESEAUX, San Carlos, CA (US); Karlin Y. BARK, San Carlos, CA (US); Pedro MARI, Santa Cruz, CA (US)

(21) Appl. No.: 19/109,052

(22) PCT Filed: Sep. 23, 2023
(86) PCT No.: PCT/US2023/033558

§ 371 Date: Mar. 5, 2025

Related U.S. Application Data
(60) Provisional application No. 63/409,775, filed on Sep. 24, 2022.

(51) Int. Cl. G06F 3/04815

(52) U.S. Cl. CPC G06F 3/04815

(57) ABSTRACT

The present disclosure generally relates to movements user interfaces.

### CROSS-REFERENCE TO RELATED APPLICATIONS

This application claims the benefit of U.S. Provisional Application No. 63/409,775, entitled “MOVEMENT USER INTERFACE,” filed Sep. 24, 2022, the entirety of which is incorporated herein by reference.

### FIELD

The present disclosure relates generally to computer user interfaces, and more specifically to techniques for indicating movement.

### BACKGROUND

Some devices capture the movement of objects in the physical environment. Such movement can be used for people to understand the physical environment and interact with others.

### SUMMARY

Some techniques for indicating movement using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for indicating movement. Such methods and interfaces optionally complement or replace other methods for indicating movement. Such methods and interfaces reduce the cognitive burden on a user and produce a more efficient human-machine interface. For battery-operated computing devices, such methods and interfaces conserve power and increase the time between battery charges.

In some embodiments, a method is performed at a computer system that is in communication with a display generation component and one or more sensors. In some embodiments, the method comprises: while the computer system is moving in an environment, displaying, via the display generation component, a user interface element with a first appearance; while displaying the user interface element: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The system also includes detecting, via the one or more sensors, data with respect to the environment; and in response to detecting data with respect to the environment: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject. The system also includes in accordance with a determination that the second set of criteria is not met, forgoing display of the representation of the subject.

In some embodiments, a non-transitory computer-readable storage medium storing one or more programs configured to be executed by one or more processors of a computer system that is in communication with a display generation component and one or more sensors. In some embodiments, the one or more programs include: while the computer system is moving in an environment, displaying, via the display generation component, a user interface element with a first appearance; while displaying the user interface element: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The programs also includes detecting, via the one or more sensors, data with respect to the environment; and in response to detecting data with respect to the environment: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject; and in accordance with a determination that the second set of criteria is not met, forgoing display of the representation of the subject.

In some embodiments, a transitory computer-readable storage medium storing one or more programs configured to be executed by one or more processors of a computer system that is in communication with a display generation component and one or more sensors. In some embodiments, the one or more programs include instructions for: while the computer system is moving in an environment, displaying, via the display generation component, a user interface element with a first appearance; while displaying the user interface element: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The programs also includes detecting, via the one or more sensors, data with respect to the environment; and in response to detecting data with respect to the environment: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject; and in accordance with a determination that the second set of criteria is not met, forgoing display of the representation of the subject.

In some embodiments, a computer system configured to communicate with a display generation component and one or more sensors is described. In some embodiments, the computer system includes one or more processors; and memory storing one or more programs configured to be executed by the one or more processors, the one or more programs including instructions for: while the computer system is moving in an environment, displaying, via the display generation component, a user interface element with a first appearance; while displaying the user interface element: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The system also includes detecting, via the one or more sensors, data with respect to the environment; and in response to detecting data with respect to the environment: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject; and in accordance with a determination that the second set of criteria is not met, forgoing display of the representation of the subject.

In some embodiments, a computer system configured to communicate with a display generation component and one or more sensors is described. In some embodiments, the computer system includes: means, while the computer system is moving in an environment, for displaying, via the display generation component, a user interface element with a first appearance; means, while displaying the user interface element, for: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The system also includes means for detecting, via the one or more sensors, data with respect to the environment; and means, responsive to detecting data with respect to the environment, for: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject. The system also includes in accordance with a determination that the second set of criteria is not met, forgoing display of the representation of the subject.

In some embodiments, a computer program product configured to communicate with a display generation component and one or more sensors. In some embodiments, the computer program product includes while the computer system is moving in an environment, displaying, via the display generation component, a user interface element with a first appearance; while displaying the user interface element: in accordance with a determination that a first set of criteria is met, continuing to display the user interface element with the first appearance; and in accordance with a determination that the first set of criteria is not met, displaying, via the display generation component, the user interface element with a second appearance that is different from the first appearance and ceasing to display the user interface element with the first appearance. The product also includes detecting, via the one or more sensors, data with respect to the environment; and in response to detecting data with respect to the environment: in accordance with a determination that a second set of criteria is met, where the second set of criteria includes a first criterion that is met when a subject is detected in the data, and where the second set of criteria include a second criterion that is met when the first set of movement criteria is not met, displaying, via the display generation component, a representation of the subject; and in accordance with a determination that the second set of criteria is not met, forgoing display of the representation of the subject.

In some embodiments, a method is performed at a computer system that is in communication with a display generation component and one or more sensors. In some embodiments, the method comprises: detecting, via the one or more sensors, data corresponding to a subject in an environment; and in response to detecting the data corresponding to the subject: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a non-transitory computer-readable storage medium storing one or more programs configured to be executed by one or more processors of a computer system that is in communication with a display generation component and one or more sensors is described. In some embodiments, the one or more programs including instructions for: detecting, via the one or more sensors, data corresponding to a subject in an environment; and in response to detecting the data corresponding to the subject: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a transitory computer-readable storage medium storing one or more programs configured to be executed by one or more processors of a computer system that is in communication with a display generation component and one or more sensors is described. In some embodiments, the one or more programs including instructions for: detecting, via the one or more sensors, data corresponding to a subject in an environment; and in response to detecting the data corresponding to the subject: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a computer system configured to communicate with a display generation component and one or more sensors is described. In some embodiments, the computer system also one or more processors; and memory storing one or more programs configured to be executed by the one or more processors, the one or more programs including instructions for: detecting, via the one or more sensors, data corresponding to a subject in an environment; and in response to detecting the data corresponding to the subject: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a computer system configured to communicate with a display generation component and one or more sensors is described. The computer system includes: means for detecting, via the one or more sensors, data corresponding to a subject in an environment; and means, responsive to detecting the data corresponding to the subject, for: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a computer program product configured to communicate with a display generation component and one or more sensors is described. In some embodiments, the computer program product includes: detecting, via the one or more sensors, data corresponding to a subject in an environment; and in response to detecting the data corresponding to the subject: in accordance with a determination that the subject meets a respective set of criteria, where the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and in accordance with a determination that the subject does not meet the respective set of criteria, forgoing displaying the first user interface object.

In some embodiments, a method is performed at a computer system that is in communication with a display generation component. In some embodiments, the method comprising: while displaying, via display generation, a respective user interface with an amount of a visual characteristic, detecting the occurrence of a respective set of movement conditions; and in response to detecting the occurrence of the respective set of movement conditions: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a non-transitory computer-readable storage medium storing one or more programs configured to be executed by one or more processors of a computer system that is in communication with a display generation component and one or more sensors is described. In some embodiments,—the one or more programs include instructions for: while displaying, via display generation, a respective user interface with an amount of a visual characteristic, detecting the occurrence of a respective set of movement conditions; and in response to detecting the occurrence of the respective set of movement conditions: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a transitory computer-readable storage medium storing one or more programs configured to be executed by one or more processors of a computer system that is in communication with a display generation component and one or more sensors is described. In some embodiments,—the one or more programs include instructions for: while displaying, via display generation, a respective user interface with an amount of a visual characteristic, detecting the occurrence of a respective set of movement conditions; and in response to detecting the occurrence of the respective set of movement conditions: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a computer system configured to communicate with a display generation component and one or more sensors is described. In some embodiments, the computer system includes one or more processors; and memory storing one or more programs configured to be executed by the one or more processors, the one or more programs including instructions for: while displaying, via display generation, a respective user interface with an amount of a visual characteristic, detecting the occurrence of a respective set of movement conditions; and in response to detecting the occurrence of the respective set of movement conditions: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a computer system configured to communicate with a display generation component and one or more sensors. In some embodiments, the computer system includes: means for while displaying, via display generation, a respective user interface with an amount of a visual characteristic, detecting the occurrence of a respective set of movement conditions; and means, responsive to detecting the occurrence of the respective set of movement conditions, for: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a computer program product is described. In some embodiments, the computer program product includes: while displaying, via display generation, a respective user interface with an amount of a visual characteristic, detecting the occurrence of a respective set of movement conditions; and in response to detecting the occurrence of the respective set of movement conditions: in accordance with a determination that the respective set of movement conditions is a first set of movement conditions, changing the amount of the visual characteristic relative to a rate of movement of the computer system; and in accordance with a determination that the respective set of movement conditions is a second set of movement conditions that is different from the first set of movement conditions, changing the amount of the visual characteristic relative to a respective rate that is different from the rate of movement of the computer system.

In some embodiments, a method is performed at a computer system that is in communication with a display generation component. In some embodiments, the method comprises: displaying, via the display generation component, a user interface that includes an indication that is displayed within a first portion of a display area and a second portion of the display area, where the first portion is different from the second portion; while displaying, via the display generation component, the user interface that includes the indication that covers the first portion and the second portion and while the computer system is in a non-stationary state, detecting a change in a movement condition; and in response to detecting the change in the movement condition and in accordance with a determination that the computer system is transitioning from the non-stationary state to a stationary state, changing, via the display generation component, the indication so that the indication is displayed within the first portion without being displayed within in the second portion.

In some embodiments, a non-transitory computer-readable storage medium storing one or more programs configured to be executed by one or more processors of a computer system that is in communication with a display generation component is described. In some embodiments, the one or more programs includes instructions for: displaying, via the display generation component, a user interface that includes an indication that is displayed within a first portion of a display area and a second portion of the display area, where the first portion is different from the second portion; while displaying, via the display generation component, the user interface that includes the indication that covers the first portion and the second portion and while the computer system is in a non-stationary state, detecting a change in a movement condition; and in response to detecting the change in the movement condition and in accordance with a determination that the computer system is transitioning from the non-stationary state to a stationary state, changing, via the display generation component, the indication so that the indication is displayed within the first portion without being displayed within in the second portion.

In some embodiments, a transitory computer-readable storage medium storing one or more programs configured to be executed by one or more processors of a computer system that is in communication with a display generation component is described. In some embodiments, the one or more programs includes instructions for: displaying, via the display generation component, a user interface that includes an indication that is displayed within a first portion of a display area and a second portion of the display area, where the first portion is different from the second portion; while displaying, via the display generation component, the user interface that includes the indication that covers the first portion and the second portion and while the computer system is in a non-stationary state, detecting a change in a movement condition; and in response to detecting the change in the movement condition and in accordance with a determination that the computer system is transitioning from the non-stationary state to a stationary state, changing, via the display generation component, the indication so that the indication is displayed within the first portion without being displayed within in the second portion

In some a computer system configured to communicate with a display generation component is described. In some embodiments, the computer system includes one or more processors; and memory storing one or more programs configured to be executed by the one or more processors, the one or more programs including instructions for: displaying, via the display generation component, a user interface that includes an indication that is displayed within a first portion of a display area and a second portion of the display area, where the first portion is different from the second portion; while displaying, via the display generation component, the user interface that includes the indication that covers the first portion and the second portion and while the computer system is in a non-stationary state, detecting a change in a movement condition; and in response to detecting the change in the movement condition and in accordance with a determination that the computer system is transitioning from the non-stationary state to a stationary state, changing, via the display generation component, the indication so that the indication is displayed within the first portion without being displayed within in the second portion.

In some embodiments, a computer system configured to communicate with a display generation component is described. In some embodiments, the computer system includes: means for displaying, via the display generation component, a user interface that includes an indication that is displayed within a first portion of a display area and a second portion of the display area, where the first portion is different from the second portion; means, while displaying, via the display generation component, for the user interface that includes the indication that covers the first portion and the second portion and while the computer system is in a non-stationary state, detecting a change in a movement condition; and means for in response to detecting the change in the movement condition and in accordance with a determination that the computer system is transitioning from the non-stationary state to a stationary state, changing, via the display generation component, the indication so that the indication is displayed within the first portion without being displayed within in the second portion.

In some embodiments, a computer program product configured to communicate with a display generation component is described. The computer program product includes: displaying, via the display generation component, a user interface that includes an indication that is displayed within a first portion of a display area and a second portion of the display area, where the first portion is different from the second portion; while displaying, via the display generation component, the user interface that includes the indication that covers the first portion and the second portion and while the computer system is in a non-stationary state, detecting a change in a movement condition; and in response to detecting the change in the movement condition and in accordance with a determination that the computer system is transitioning from the non-stationary state to a stationary state, changing, via the display generation component, the indication so that the indication is displayed within the first portion without being displayed within in the second portion.

In some embodiments, a method is performed at a computer system that is in communication with a display generation component and a physical mechanism. In some embodiments, the method comprises: displaying, via the display generation component, a first user interface; while displaying the first user interface, detecting an occurrence of a condition; and in response to detecting the occurrence of the condition: displaying, via the display generation component, a second user interface that is different from the first user interface; and causing the physical mechanism to lower the computer system.

In some embodiments, a non-transitory computer-readable storage medium storing one or more programs configured to be executed by one or more processors of a computer system that is in communication with a display generation component and a physical mechanism is described. In some embodiments, the one or more programs include instructions for: displaying, via the display generation component, a first user interface; while displaying the first user interface, detecting an occurrence of a condition; and in response to detecting the occurrence of the condition: displaying, via the display generation component, a second user interface that is different from the first user interface; and causing the physical mechanism to lower the computer system.

In some embodiments, a transitory computer-readable storage medium storing one or more programs configured to be executed by one or more processors of a computer system that is in communication with a display generation component and a physical mechanism is described. In some embodiments, the one or more programs include instructions for: displaying, via the display generation component, a first user interface; while displaying the first user interface, detecting an occurrence of a condition; and in response to detecting the occurrence of the condition: displaying, via the display generation component, a second user interface that is different from the first user interface; and causing the physical mechanism to lower the computer system.

In some embodiments, a computer system configured to communicate with a display generation component and a physical mechanism is described. In some embodiments, computer system includes one or more processors; and memory storing one or more programs configured to be executed by the one or more processors, the one or more programs including instructions for: displaying, via the display generation component, a first user interface; while displaying the first user interface, detecting an occurrence of a condition; and in response to detecting the occurrence of the condition: displaying, via the display generation component, a second user interface that is different from the first user interface; and causing the physical mechanism to lower the computer system.

In some embodiments, a computer system configured to communicate with a display generation component and one or more sensors is described. The computer system includes means: for displaying, via the display generation component, a first user interface; means, while displaying the first user interface, for detecting an occurrence of a condition; and means, responsive to detecting the occurrence of the condition, for: displaying, via the display generation component, a second user interface that is different from the first user interface; and causing the physical mechanism to lower the computer system.

In some embodiments, a computer system product configured to communicate with a display generation component and one or more sensors is described. The computer program product includes: displaying, via the display generation component, a first user interface; while displaying the first user interface, detecting an occurrence of a condition; and in response to detecting the occurrence of the condition: displaying, via the display generation component, a second user interface that is different from the first user interface; and causing the physical mechanism to lower the computer system.

In some embodiments, a method is performed at a computer system that is in communication with a first display generation and a second display generation component. The method comprises: while the computer system is moving, displaying, via the first display generation component, a first user interface element with a first appearance; while displaying the first user interface element with the first appearance, detecting occurrence of one or more events; and in response to detecting the occurrence of the one or more events. The method also includes in accordance with a determination that the one or more events include a first event, where the first event is detected when a determination is made that the computer system is moving, continuing to display the first user interface element with the first appearance. The method also includes in accordance with a determination that the one or more events does not include the first event, displaying, via the first display generation component, the first user interface element with a second appearance that is different from the first appearance. The method also includes in accordance with a determination that the one or more events includes a second event that is a different type of event than the first event, displaying, via a second display generation component, a second user interface element that at least partially circumscribes the first user interface element. The method also includes in accordance with a determination that the one or more events does not include the second event, forgoing display, via the second display generation component, of the second user interface element.

In some embodiments, a non-transitory computer-readable storage medium storing one or more programs configured to be executed by one or more processors of a computer system that is in communication with a first display generation component and a second display generation component is described. In some embodiments, one or more programs includes instructions for while the computer system is moving, displaying, via the first display generation component, a first user interface element with a first appearance; while displaying the first user interface element with the first appearance, detecting occurrence of one or more events; and in response to detecting the occurrence of the one or more events: in accordance with a determination that the one or more events include a first event, where the first event is detected when a determination is made that the computer system is moving, continuing to display the first user interface element with the first appearance; in accordance with a determination that the one or more events does not include the first event, displaying, via the first display generation component, the first user interface element with a second appearance that is different from the first appearance; in accordance with a determination that the one or more events includes a second event that is a different type of event than the first event, displaying, via a second display generation component, a second user interface element that at least partially circumscribes the first user interface element; and in accordance with a determination that the one or more events does not include the second event, forgoing display, via the second display generation component, of the second user interface element.

In some embodiments, a transitory computer-readable storage medium storing one or more programs configured to be executed by one or more processors of a computer system that is in communication with a first display generation component and a second display generation component is described. In some embodiments, one or more programs includes instructions for while the computer system is moving, displaying, via the first display generation component, a first user interface element with a first appearance; while displaying the first user interface element with the first appearance, detecting occurrence of one or more events; and in response to detecting the occurrence of the one or more events: in accordance with a determination that the one or more events include a first event, where the first event is detected when a determination is made that the computer system is moving, continuing to display the first user interface element with the first appearance; in accordance with a determination that the one or more events does not include the first event, displaying, via the first display generation component, the first user interface element with a second appearance that is different from the first appearance; in accordance with a determination that the one or more events includes a second event that is a different type of event than the first event, displaying, via a second display generation component, a second user interface element that at least partially circumscribes the first user interface element; and in accordance with a determination that the one or more events does not include the second event, forgoing display, via the second display generation component, of the second user interface element.

In some embodiments, a computer system configured to communicate with a first display generation component and a second display generation component. In some embodiments, computer system also includes one or more processors; and memory storing one or more programs configured to be executed by the one or more processors, the one or more programs including instructions for: while the computer system is moving, displaying, via the first display generation component, a first user interface element with a first appearance; while displaying the first user interface element with the first appearance, detecting occurrence of one or more events; and in response to detecting the occurrence of the one or more events: in accordance with a determination that the one or more events include a first event, where the first event is detected when a determination is made that the computer system is moving, continuing to display the first user interface element with the first appearance; in accordance with a determination that the one or more events does not include the first event, displaying, via the first display generation component, the first user interface element with a second appearance that is different from the first appearance; in accordance with a determination that the one or more events includes a second event that is a different type of event than the first event, displaying, via a second display generation component, a second user interface element that at least partially circumscribes the first user interface element; and in accordance with a determination that the one or more events does not include the second event, forgoing display, via the second display generation component, of the second user interface element.

In some embodiments, a computer system configured to communicate with a first display generation component and a second display generation component is described. In some embodiments, the computer system includes means, while the computer system is moving, displaying, via the first display generation component, for a first user interface element with a first appearance; means, while displaying the first user interface element with the first appearance, for detecting occurrence of one or more events; and means, responsive to detecting the occurrence of the one or more events, for: in accordance with a determination that the one or more events include a first event, where the first event is detected when a determination is made that the computer system is moving, continuing to display the first user interface element with the first appearance; in accordance with a determination that the one or more events does not include the first event, displaying, via the first display generation component, the first user interface element with a second appearance that is different from the first appearance; in accordance with a determination that the one or more events includes a second event that is a different type of event than the first event, displaying, via a second display generation component, a second user interface element that at least partially circumscribes the first user interface element; and in accordance with a determination that the one or more events does not include the second event, forgoing display, via the second display generation component, of the second user interface element.

In some embodiments, a computer program product configured to communicate with a first display generation component and a second display generation component is described. In some embodiments, the computer program product includes: while the computer system is moving, displaying, via the first display generation component, a first user interface element with a first appearance; while displaying the first user interface element with the first appearance, detecting occurrence of one or more events; and in response to detecting the occurrence of the one or more events: in accordance with a determination that the one or more events include a first event, where the first event is detected when a determination is made that the computer system is moving, continuing to display the first user interface element with the first appearance; in accordance with a determination that the one or more events does not include the first event, displaying, via the first display generation component, the first user interface element with a second appearance that is different from the first appearance; in accordance with a determination that the one or more events includes a second event that is a different type of event than the first event, displaying, via a second display generation component, a second user interface element that at least partially circumscribes the first user interface element; and in accordance with a determination that the one or more events does not include the second event, forgoing display, via the second display generation component, of the second user interface element. Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for indicating movement, thereby increasing the effectiveness, efficiency, and user satisfaction with such devices. Such methods and interfaces may complement or replace other methods for indicating movement.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6F illustrate exemplary user interfaces for indicating movement using computer system 600 in accordance with some embodiments.

FIG. 7 is a flow diagram illustrating a method for indicating movement of a computer system and a subject in accordance with some embodiments.

FIG. 8 is a flow diagram illustrating a method for indicating awareness of a subject using a computer system in accordance with some embodiments.

FIG. 9 is a flow diagram illustrating a method for indicating acceleration using a computer system in accordance with some embodiments.

FIG. 10 is a flow diagram illustrating a method for indicating movement of a computer system in accordance with some embodiments.

FIG. 11 is a flow diagram illustrating a method for indicating no movement using a computer system in accordance with some embodiments.

FIG. 12 is a flow diagram illustrating a method for indicating movement information using a computer system in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for indicating movement. Such techniques can reduce the cognitive burden on a user, thereby enhancing productivity. Further, such techniques can reduce processor and battery power otherwise wasted on redundant user inputs.

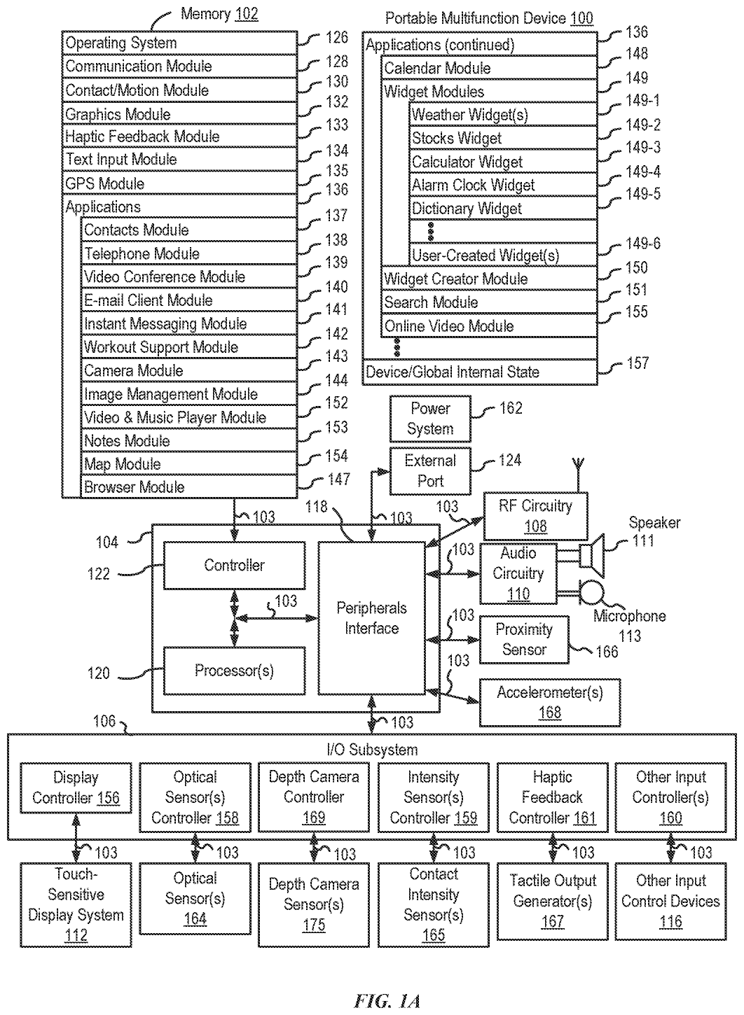

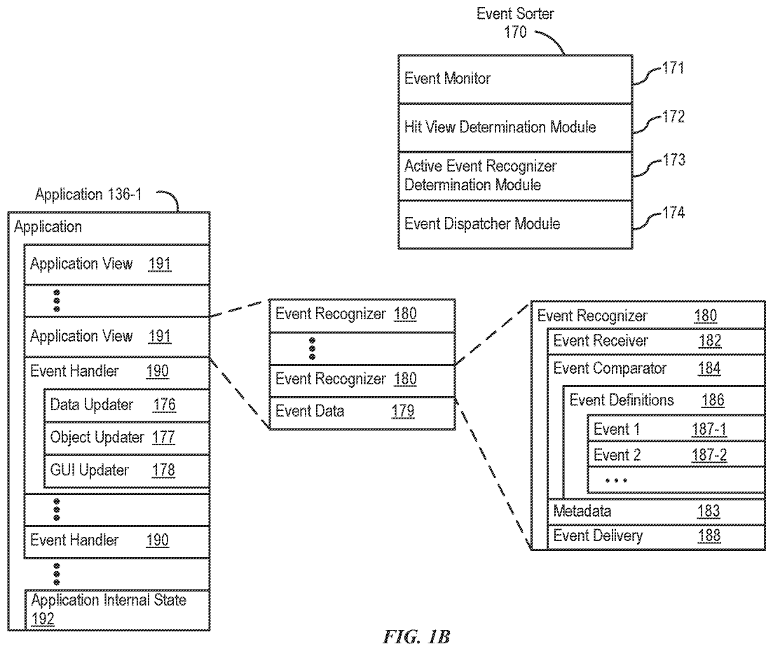

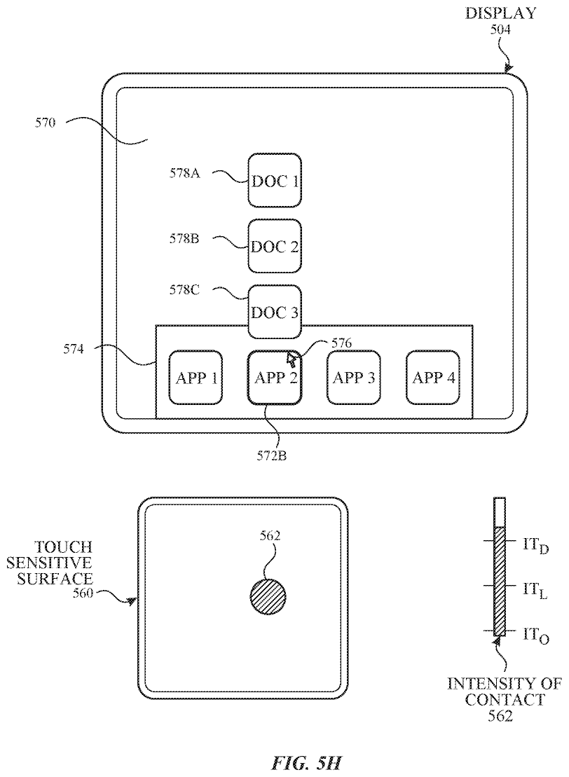

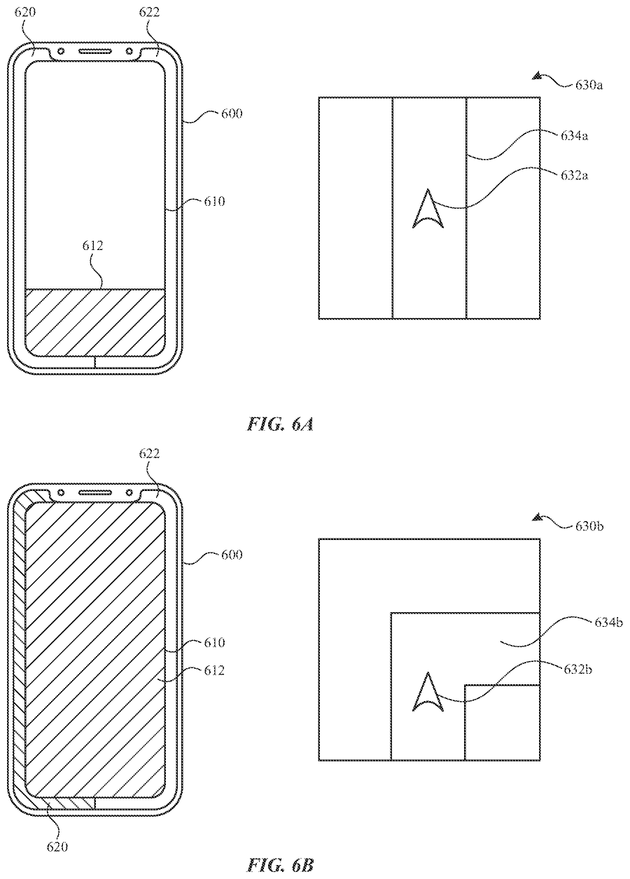

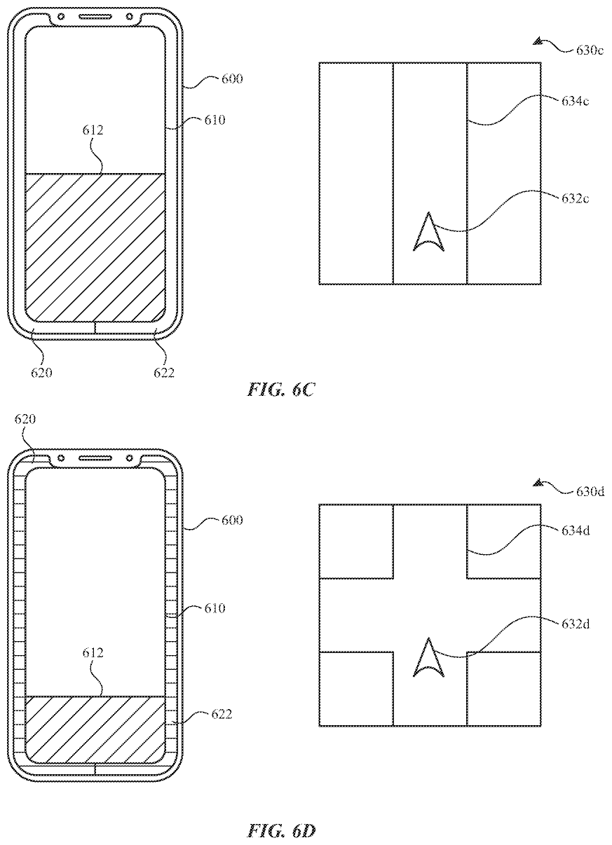

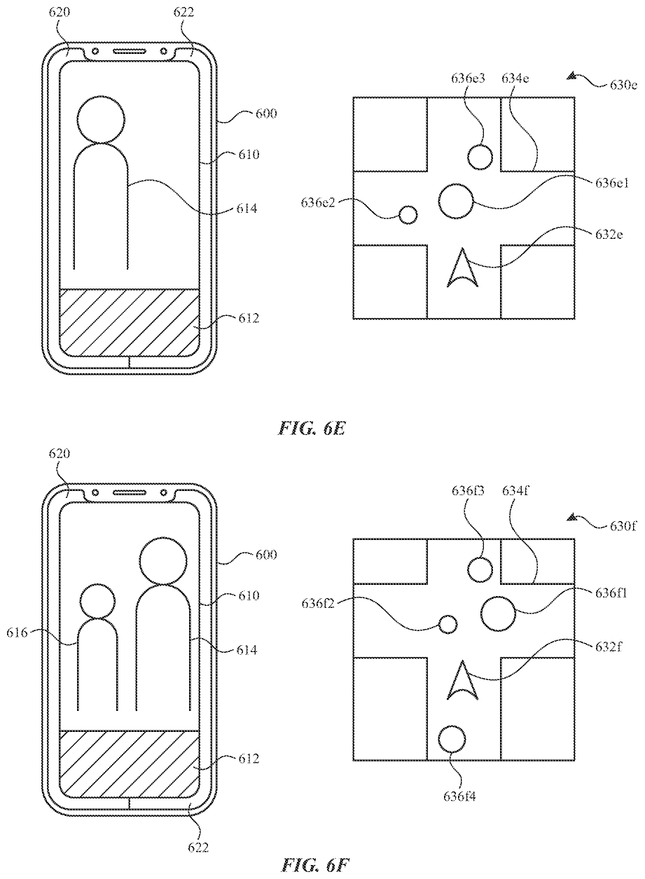

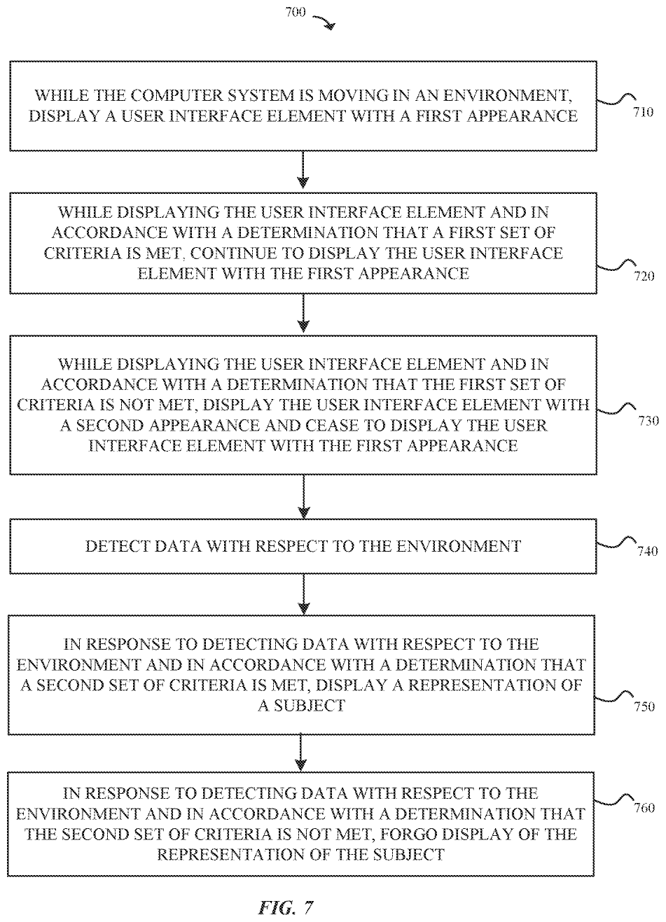

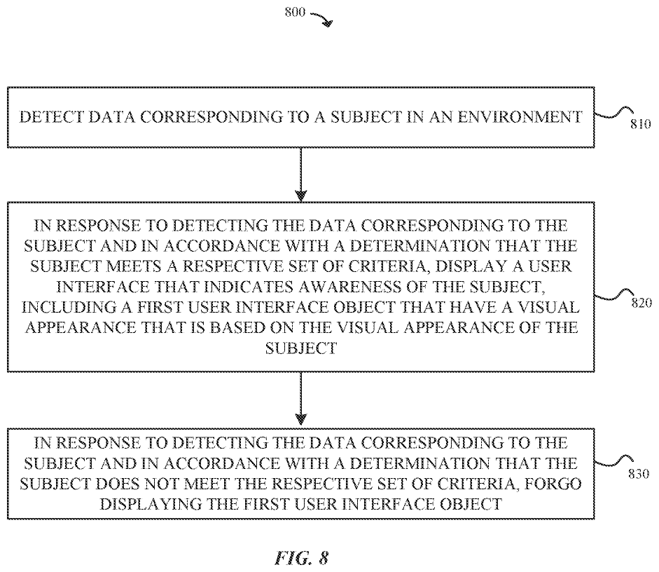

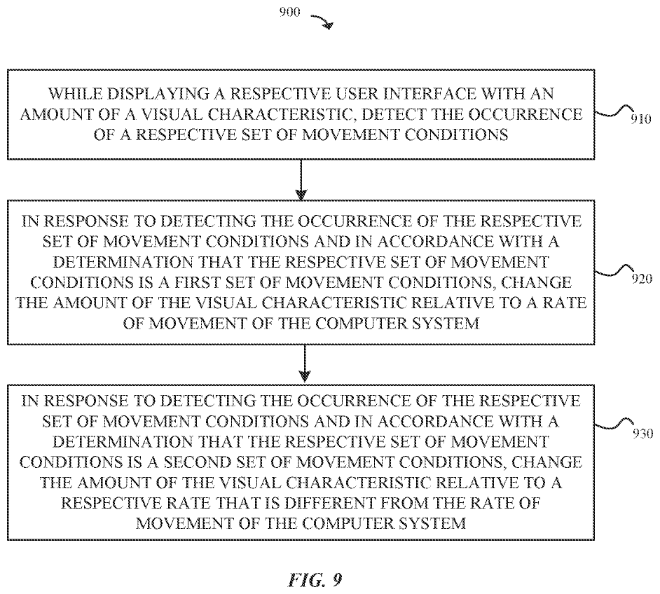

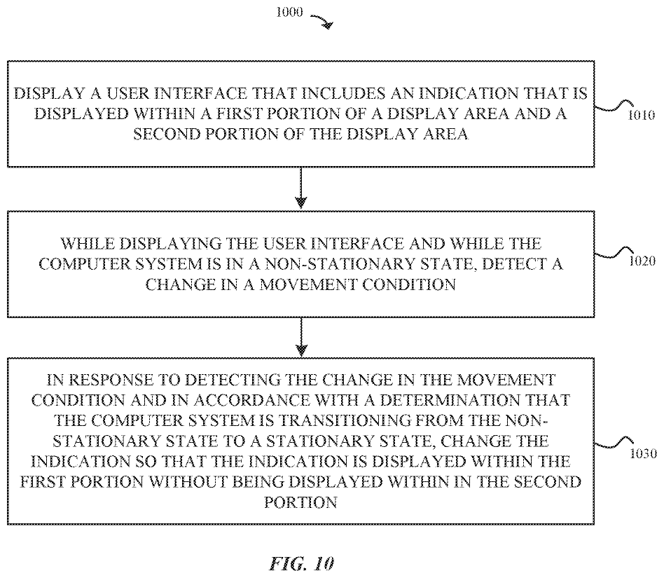

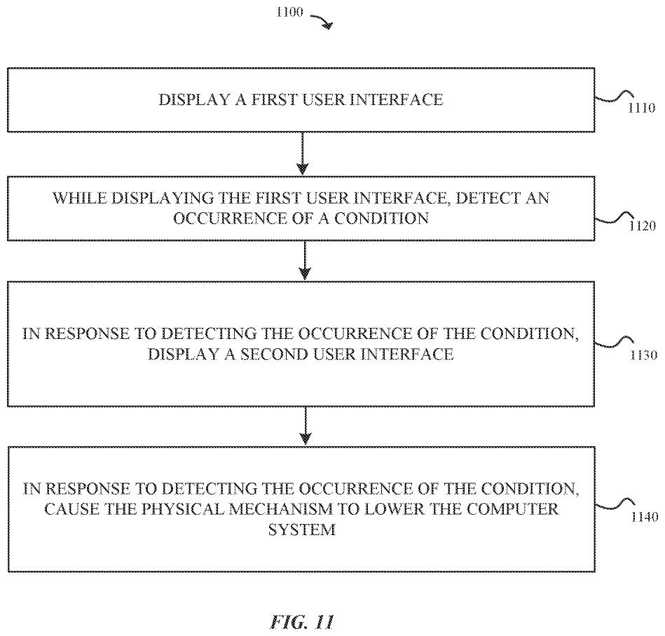

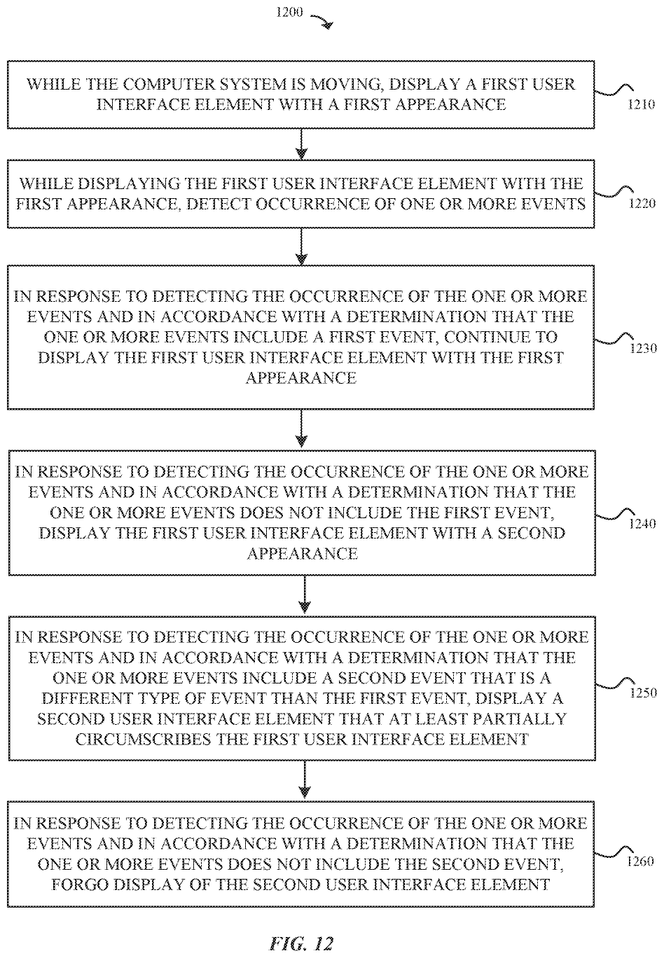

Below, FIGS. 1A-1B, 2, 3, 4A-4B, and 5A-5H provide a description of exemplary devices for performing the techniques for managing event notifications. FIGS. 6A-6F illustrate exemplary user interfaces for indicating movement. FIG. 7 is a flow diagram illustrating a method for indicating movement of a computer system and a subject in accordance with some embodiments. FIG. 8 is a flow diagram illustrating a method for indicating awareness of a subject using a computer system in accordance with some embodiments. FIG. 9 is a flow diagram illustrating a method for indicating acceleration using a computer system in accordance with some embodiments. FIG. 10 is a flow diagram illustrating a method for indicating movement of a computer system in accordance with some embodiments. FIG. 11 is a flow diagram illustrating a method for indicating no movement using a computer system in accordance with some embodiments. FIG. 12 is a flow diagram illustrating a method for indicating movement information using a computer system in accordance with some embodiments. The user interfaces in FIGS. 6A-6F are used to illustrate the processes described below, including the processes in FIGS. 7-12.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

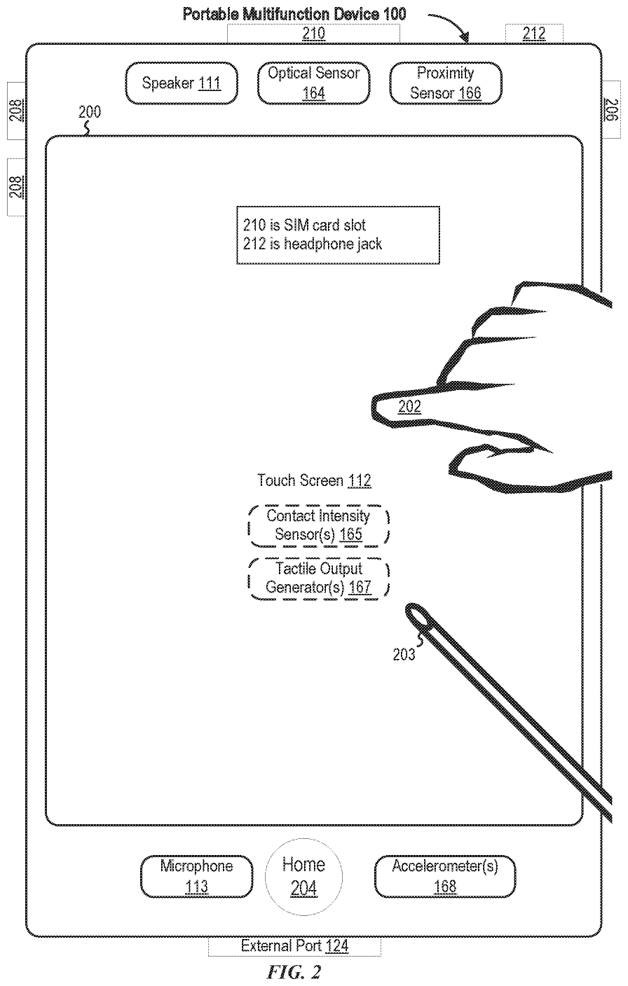

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), 6,570,557 (Westerman et al.), and/or 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three-dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

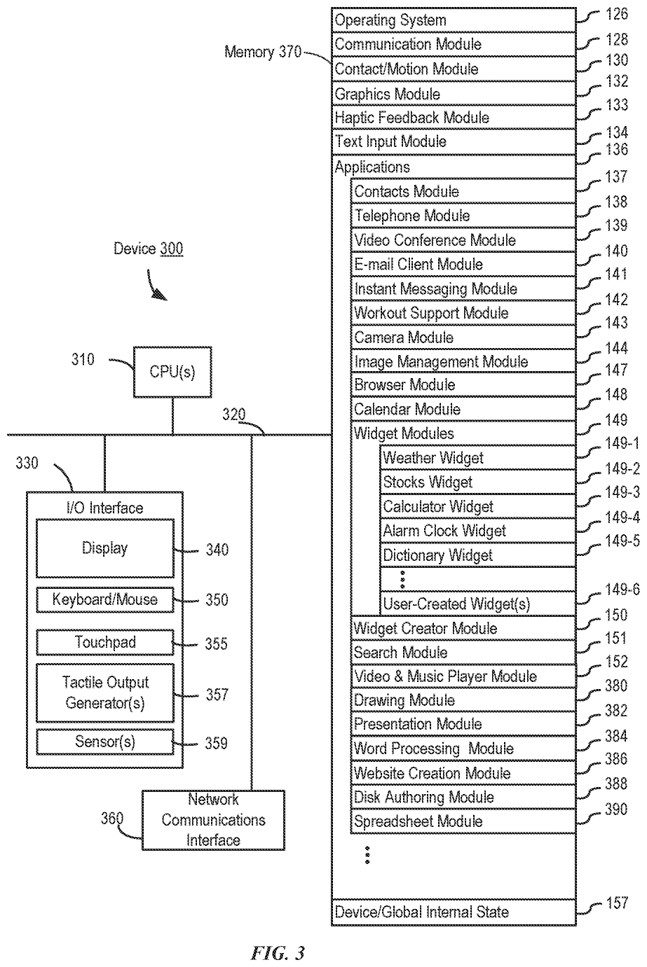

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

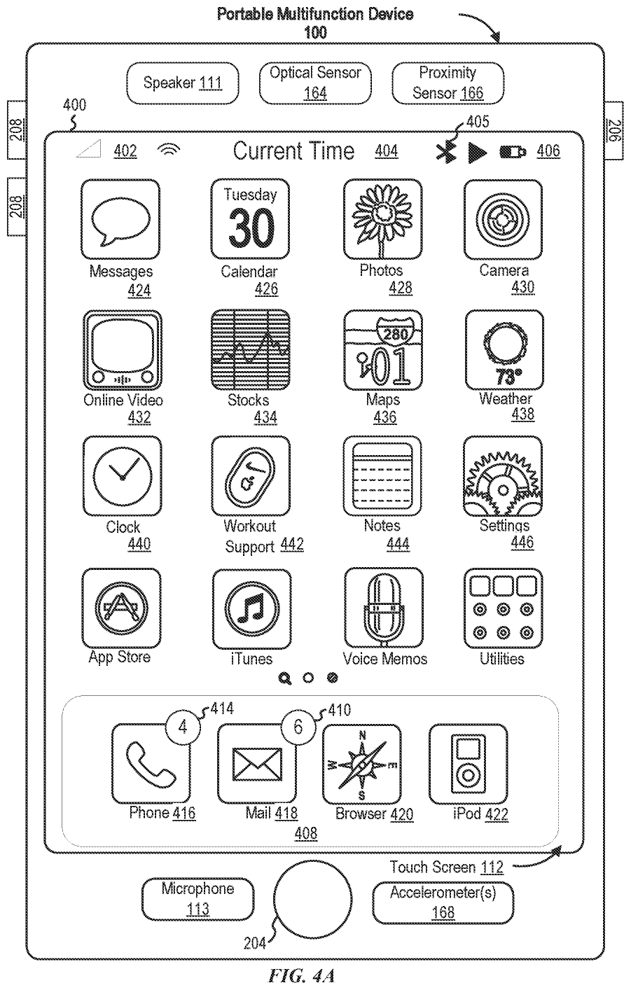

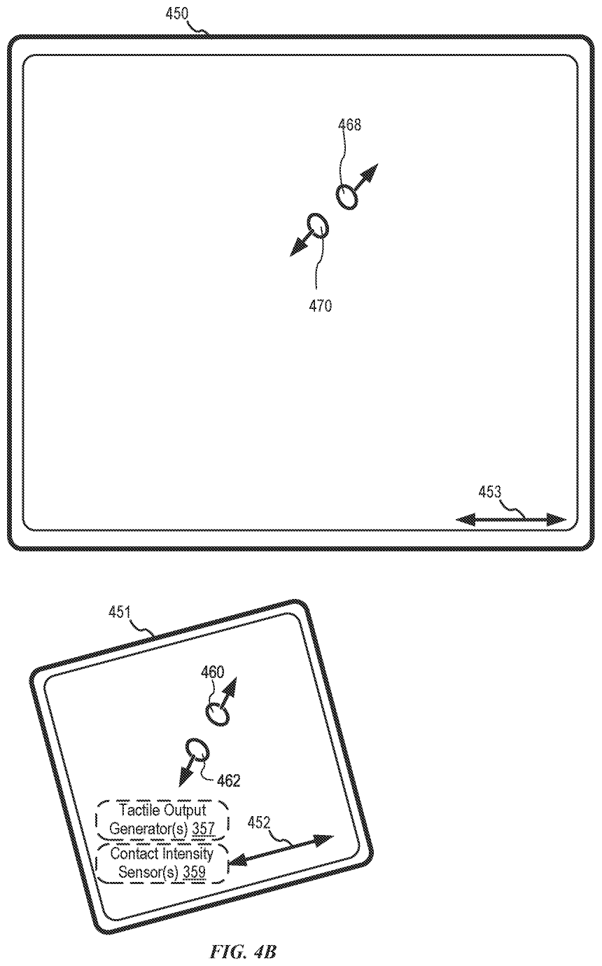

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

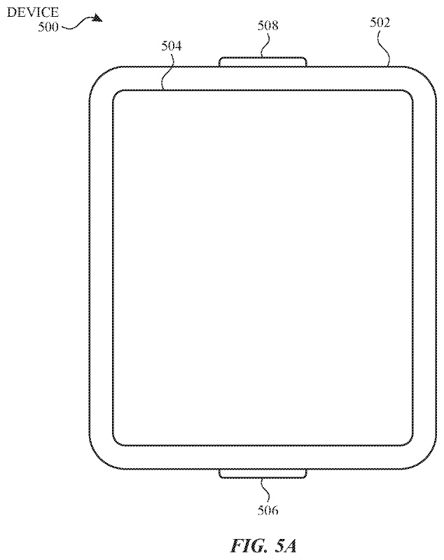

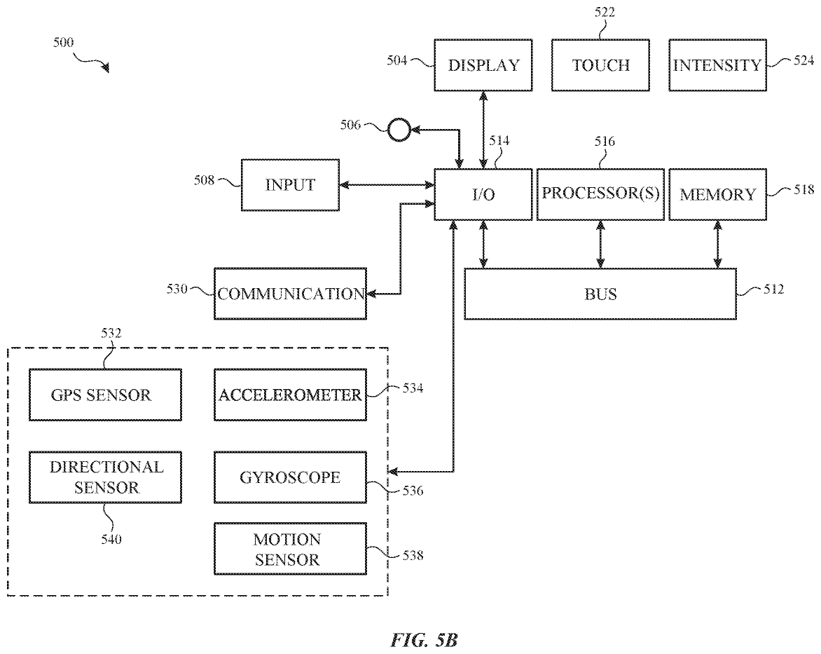

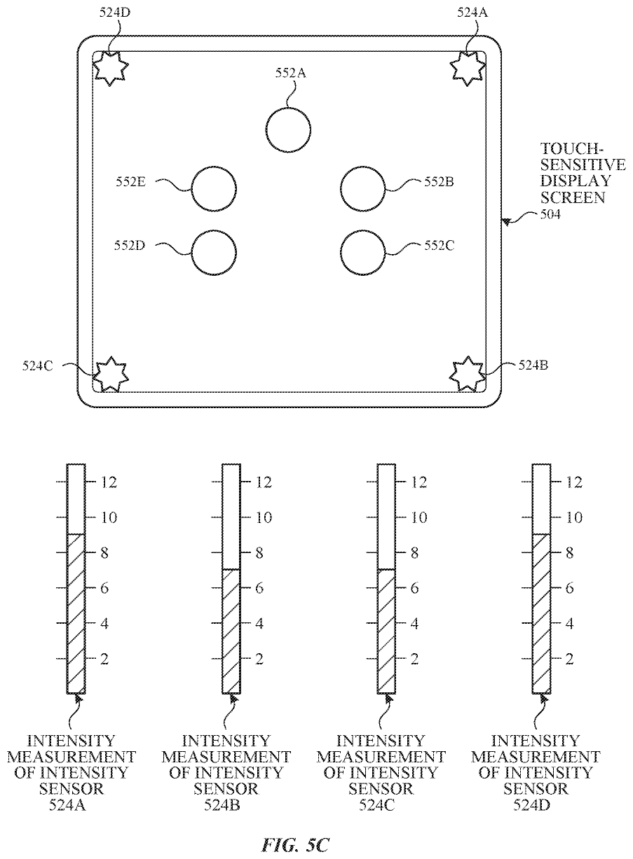

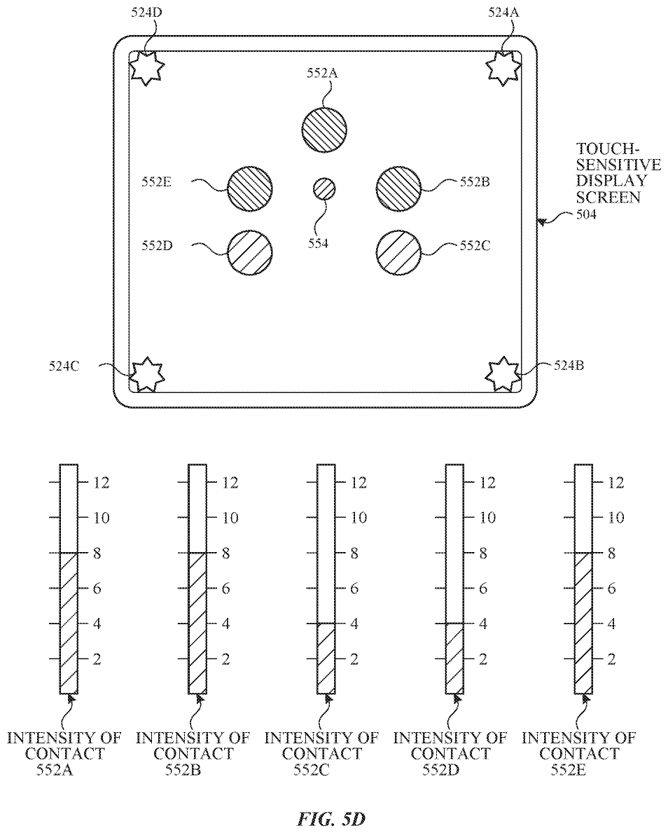

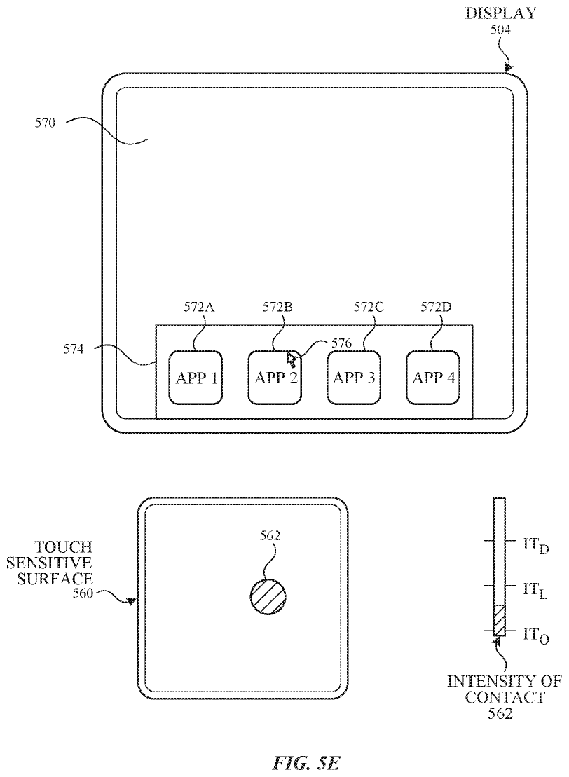

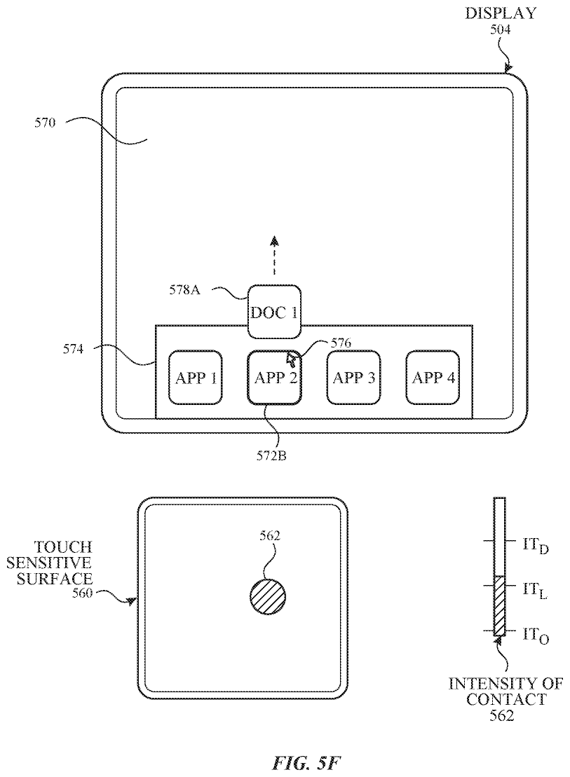

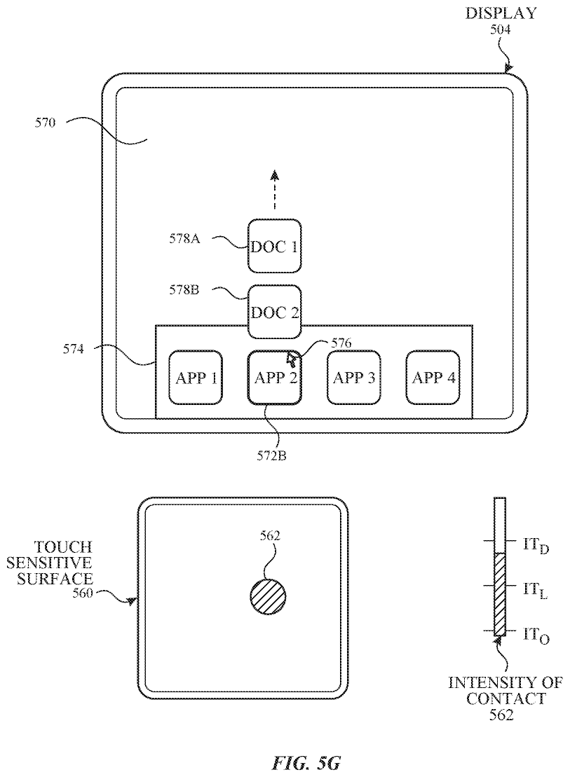

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700-1200 (FIGS. 7-12). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “IT_{L}”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as portable multifunction device 100, device 300, or device 500.

FIGS. 6A-6F illustrate exemplary user interfaces for indicating movement using a computer system in accordance with some embodiments. The user interfaces in these figures are used to illustrate the processes described below, including the processes in FIGS. 7-12.

In some embodiments, the techniques and processes described below are directed to an accessibility feature, where a user can communicate information (e.g., whether the user is moving or not moving) via a computer system by means other than verbal communication. In some embodiments, the techniques and processes described below allow for other people in the physical environment to obtain information concerning the movement of the user, the user's intended movement, and/or other information being conveyed by the user. In some embodiments, the user holds a computer system in an orientation where the computer system's display is facing away from the user, such that other users in the physical environment can see the information displayed by the user's computer system. In some embodiments, the computer system automatically displays and/or updates portions of a user interface based on, in-part, the movement of the user.

FIG. 6A illustrates computer system 600 displaying a user interface that includes display area 610, right display area 620, and left display area 622. As illustrated in FIG. 6A, display area 610, right display area 620, and left display area 622 are displayed via a single display that is physically coupled to computer system 600. Right display area 620 partially surrounds and/or circumscribes display area 610, and left display area 622 partially circumscribes display area 610. In some embodiments, one or more of right display area 620 and left display area 622 fully circumscribe display area 610. In some embodiments, computer system 600 includes one or more features and/or components of computer systems 100, 300, and/or 500 described above. In some embodiments, display area 610, right display area 620, and left display area 622 are each displayed via separate displays that are physically and/or wirelessly coupled to computer system 600. In some embodiments, right display area 620 and/or left display area 622 are displayed on another computer system, such as smartwatch, a tablet, another smartphone, and/or a fitness tracking device, while computer system 600 displays display area 610. In one or more of such embodiments, display area 610 takes up the entire display of computer system 600. In some embodiments, when right display area 620 and/or left display area 622 are displayed on another computer system, right display area 620 can be displayed on a computer system that is positioned on a right side of the user while left display area 622 can be displayed on a computer system that is positioned on a left side of the user.

As illustrated in FIG. 6A, display area 610 includes visual characteristic 612. Visual characteristic 612 is a color that fills a portion of display area 610 while another portion of display area 610 is filled with another color. In some embodiments, display area 610 includes more colors (e.g., more than two colors) than the two colors of display area 610. In some embodiments, computer system 600 displays right display 620 and/or left display area 612 with the same visual characteristic as visual characteristic 612. In some embodiments, visual characteristic is the color black, and the other part of display area 610 that does not include visual characteristic includes a different color than black. In some embodiments, the different color resembles and/or is the color of light (e.g., a soft white and/or yellow). In some embodiments, visual characteristic 612 is a level of brightness, a tint, a tone, and/or a hue. In some embodiments, visual characteristic 612 is an image (e.g., an image that includes or does not include text) and/or is a video.

FIG. 6A includes map information 630a, which is being provided to indicate the user's location and the user's movement in the physical environment. Map information 630a includes location indicator 632a that is traveling along path 632a. For purposes of discussion, at FIG. 6A, a user who is holding computer system 600 is standing on path 632a in the direction of the arrow indicated by location indicator 632a. At FIG. 6A, in response to detecting movement of computer system 600 (or the user) and a determination is made that computer system 600 will not be stationary for a predetermined period of time (e.g., with 0-2 minutes). In some embodiments, the determination is made that computer system 600 (or the user) is starting to move (and/or will not be stationary within (or after) a predetermined period of time). In some embodiments, the determination made that computer system 600 will begin moving based on detecting one or more actions of the user, such as the user interacting with the computer system, the user or the computer system starting to move, and/or the user sending one or more request to the computer system. In some embodiments, the determination is made that computer system 600 will begin moving based on one or more micro movements (e.g., small vibrations) made by the user, such as movements that can be detected by a gyroscope and/or a heart rate sensor.

As illustrated in FIG. 6B, based on the determination being made that computer system 600 will begin moving, computer system 600 increases the size of visual characteristic 612, where visual characteristic 612 covers more of display area 610 in FIG. 6B than visual characteristic 612 covered in FIG. 6B. As a part of increasing the size of visual characteristic 612, computer system 600 displays an animation of visual characteristic 612 filling up display area over time (e.g., a slide up animation and/or a filling animation, where visual characteristic 612 slows rises upward to cover more of display area 610). At FIG. 6B, the rate of the animation includes visual characteristic 612 filling up display area 610 is not based on the rate of movement of computer system 600. In some embodiments, based on the determination being made that computer system 600 will begin moving, visual characteristic 612 fills up display area 610 based on a predetermined rate that is not based on the movement of computer system 600 (and/or user). In some embodiments, display of the animation of visual characteristic 612 filling up display area 610 is completed before computer system 600 is moved in a lateral direction (e.g., direction of a user walking, running, and/or jogging along the group). In some embodiments, computer system 600 displays a portion of the animation of visual characteristic 612 filling up display area 610 before computer system 600 is moved and another portion of the animation is displayed after computer system 600 is moved. In some embodiments, before filling up display area 610 with visual characteristic 612, computer system 600 initial outputs a respective sound. In some embodiments, the respective sound has a single tone and/or is output for a short period of time (e.g., less than 1 second). In some embodiments, after outputting the respective sound, computer system 600 beings to output a different sound as the animation of visual characteristic 612 filling up display area 610 is displayed. In some embodiments, the different sound is longer than the respective sound (or is not shorter than the respective sound). In some embodiments, the difference in sound increases in tone and/or volume proportionally in relation to the rate at which the animation of visual characteristic 612 is displayed.

At FIG. 6B, computer system 600 will continue to display area 610 and visual characteristic 612 as presented in FIG. 6B until a determination is made that computer system 600 has stopped or is being to stop (e.g., as further discussed below in relation to FIGS. 6C-6D). At FIG. 6B, a determination is made that the user of computer system 600 will need to turn right (and/or that computer system 600 will be moved in a way, where it will turn right with the user). As illustrated in FIG. 6C, in response to determination that the user of computer system 600 will need to turn right, computer system 600 displays a visual characteristic in right display area 620, which is similar to the visual characteristic 612. Notably, at FIG. 6B, computer system 600 does not display a visual characteristic in right display area 620 because the determination was made that the user of computer system 600 will need to turn right (and not left). In some embodiments, the visual characteristic in right display area 620 is a different color, level of brightness, and/or hue than visual characteristic 612; in some embodiments, it is the same. In some embodiments, the visual characteristic in right display area 620 pulsates (e.g., light a turn signal) while visual characteristic 612 does not pulsate. In some embodiments, computer system 600 displays hazard information (e.g., identical visual characteristics in right display area 620 and left display 622) that pulsate at the same time (e.g., like a hazard signal) using right display area 620 and left display 622. In some embodiments, computer system 600 displays the hazard information right display area 620 and left display 622 based on a determination that computer system 600 is malfunctioning and/or a determination is made that a user of the computer system 600 would like to convey hazard information (e.g., the user is distressed, the user is tired, the user is sleepy, and/or the user is lost, etc.). Thus, looking at FIG. 6B, computer system 600 can use right display area 620 and left display 622 to indicate information concerning future actions and/or potential actions (e.g., left turn, right turn, and/or hazard information) while using display area 610 to display information concerning whether computer system 600 is being moved or not (and/or whether the user is moving or not). At FIG. 6B, a determination is made that computer system 600 (or the user) is coming to a stop and/or will stop moving with a predetermined period of time. In some embodiments, the determination is made computer system 600 (or the user) is coming to a stop because the user (and/or computer system 600) is approaching a street sign, crosswalk (e.g., indicated by 632d and 634d in map information 630d of FIG. 6D), a bike path, people, and/or a hazard.

As illustrated in FIG. 6C, based on the determination being made that computer system 600 is coming to a stop, computer system 600 reduces the amount of visual characteristic 612 displayed in display area 610. Here, computer system 600 reduces the amount of visual characteristic 612 displayed in display area 610 by displaying an animation of visual characteristic being removed from display area 610 (e.g., a slide down animation). In some embodiments, the rate of the animation (e.g., the speed at which visual characteristic 612 is removed) is based on the movement of computer system 600. In some embodiments, as computer system 600 (and/or user) comes to a stop at a faster rate, computer system 600 removes visual characteristic 612 at a faster rate. In some embodiments, computer system 600 outputs a sound while reducing the amount of visual characteristic 612. In some embodiments, the volume or tone of the sound decreases proportionally to the reduction in the amount of visual characteristic 612.

FIG. 6D illustrates an embodiment where computer system 600 has completed removing visual characteristic 612 from display area 610 based on the determination being made that computer system 600 (and/or user) is coming to a stop. At FIG. 6D, the user of computer system 600 has fully stopped, and most of visual characteristic 612 has been removed. However, at FIG. 6D, a portion of visual characteristic 612 remains in display area 610 (e.g., the same portion that was there when computer system 600 was original stopped in FIG. 6A).

At FIG. 6E, computer system 600 detects four people (e.g., 636e1-336e3) surrounding computer system 600 and the user. As indicated by map information 630e, person 636e1 is directly in from the user (e.g., as indicated by indication 632e), person 636e2 is to the left of the user, person 636e3 is in front of the user but further back than person 636e1. At FIG. 6E, each person is detected by one or more sensors (e.g., one or more of the same and/or different sensors) of computer system 600, such as one or more cameras. However, computer system 600 only displays a representation of person 632e1 (e.g., representation 614) in display area 614. Computer system 600 displays representation 614 because a determination is made that person 632e1 is within a predetermined area (e.g., direction and distance) from computer system 600. In particular, computer system 600 displays representation 614 because person 632e1 is within a predetermined distance in front of computer system 600. Computer system 600 does not display a representation that corresponds to person 636e2 because a determination is made that person 636e2 is outside of the predetermined area (e.g., direction) of computer system 600. Moreover, computer system 600 does not display a representation that corresponds to person 636e3 because a determination is made that person 636e3 is outside of the predetermined area (e.g., distance) of computer system 600.

Notably, at FIG. 6E, computer system 600 displays representation 614 (e.g., for the person that is within the predetermined area) in display area 610 while a portion of visual characteristic 612 continues to be displayed in display area 614. In some embodiments, representation 614 is not a live feed and/or does not actually resemble (e.g., look like) person 636e1. In some embodiments, representation 614 is a blob, where a same size and/or shape of person 636e1 is represented by representation 614. However, representation 614, in some embodiments, does not include one or more facial features of person 636e1. In some embodiments, representation 614 is displayed having visual characteristic 612. In such embodiments, representation 614 has the same color (or brightness) as visual characteristic 612. In some embodiments, computer system 600 moves representation 614, such that representation 614 mimics the movement of person 636e1 in the physical environment. In some embodiments, computer system 600 ceases to display person 636e1 when a determination is made that person 636e1 has moved outside of the predetermined area or zone that is within a predetermined distance in front of computer system 600.

FIG. 6F illustrates computer system 600 displays representation 614 and representation 616 in display area 610 while a portion of visual characteristic 612 is displayed. At FIG. 6F, computer system 600 displays representation 614 and representation 616 because people (e.g., person 636f1 and 636f2) corresponding to representations 614 and 616 are within the predetermined area (e.g., determined using one or more techniques described above in relation to FIG. 6E). At FIG. 6F, person 636f is behind computer system 600 and, although one or more sensors of computer system 600, computer system 600 does not display a representation that corresponds to person 636f because person 636f is not within the predetermined area discussed above. In some embodiments, the predetermined area is continuous area. In some embodiments, the predetermined area is not a continuous area, such as an area that is within the blind spots of computer system 600. In some embodiments, computer system 600 does not display a visual representation of a subject that is not a person (and/or an animal) even if the subject or object is within the predetermined area. Thus, in some embodiments, computer system 600 displays representations for some subjects and not others when computer system 600 is stopped. In some embodiments, while computer system 600 is moving, computer system 600 does not display a representation of the subject via display area 610. While FIGS. 6A-6F have been described above in relation to an accessibility feature, it should be understood that the techniques above could be used in one or more other applications. For example, display areas 610-614 could be headlights on a vehicle, where the vehicle (e.g., a boat, a bike, a truck, and/or a truck) would display the user interface of FIGS. 6A-6F via display area 610-614, using one or more techniques described herein, based on movement of the vehicle.

FIG. 7 is a flow diagram illustrating a method for indicating movement of a computer system and a subject in accordance with some embodiments. Method 700 is performed at a computer system (e.g., 100, 300, 500, and/or 600) that is in communication with a display generation component (e.g., display screen and/or a touch-sensitive display) and one or more sensors (e.g., one or more telephoto, wide angle, and/or ultra-wide-angle cameras) and/or one or more sensors (e.g., temperature, lidar, radar, and/or motion). In some embodiments, the computer system is a watch, a fitness tracking device, a phone, a tablet, a processor, a head-mounted display (HMD) device, and/or a personal computing device. Some operations in method 700 are, optionally, combined, the orders of some operations are, optionally, changed, and some operations are, optionally, omitted.

As described below, method 700 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 710 of method 700, the computer system, while the computer system is moving (e.g., is not stationary and/or is moving laterally, vertically, and/or horizontally) (and/or while a set of movement conditions are satisfied) in an environment (e.g., a physical environment and/or a virtual environment), displays, via the display generation component (e.g., a display (e.g., the entire display or a portion of the display that is not the entire display)), a user interface element with a first appearance.

At 720 of method 700, the computer system, while displaying the user interface element and in accordance with a determination that a first set of criteria is met (e.g., a determination is made that the computer system is moving and/or a determination is made that the computer system will start moving within a predetermined period of time), continues to display the user interface element with the first appearance.

At 730 of method 700, the computer system, while displaying the user interface element and in accordance with a determination that the first set of criteria is not met, displays, via the display generation component, the user interface element with a second appearance that is different from the first appearance and ceasing to display the user interface element with the first appearance.

At 740 of method 700, the computer system detects, via the one or more sensors, data with respect to the environment.

At 750 of method 700, the computer system, in response to detecting data with respect to the environment and in accordance with a determination that a second set of criteria is met, wherein the second set of criteria includes a first criterion that is met when a subject is detected in the data (e.g., people and/or animals), and wherein the second set of criteria include a second criterion that is met when the first set of movement criteria is not met, displays, via the display generation component, a representation of the subject.

At 760 of method 700, the computer system, in response to detecting data with respect to the environment and in accordance with a determination that the second set of criteria is not met, forgoes display of the representation of the subject. Displaying, via the display generation component, the user interface element with a second appearance based on prescribed allows computer system to display information concerning the state of the computer system when deemed appropriate, which performs an operation when a set of conditions has been met without requiring further user input and provides improved feedback to the user and provide improved feedback to the user.

In some embodiments, displaying the user interface element (e.g., 610) with the first appearance (e.g., a count-down and/or count-up clock and/or a display area being filled up and/or unfilled) indicates that the computer system will not be stationary within a first predetermined period of time (e.g., within 0-5 minutes) (e.g., the computer system is moving for and/or will be moving within the first predetermined period of time or after the predetermined period of the time has passed). In some embodiments, displaying the user interface element (e.g., 610) with the second visual appearance (e.g., a count-down and/or count-up clock and/or a display area being filled up and/or unfilled) indicates that the computer system will be stationary within the first predetermined period of time. Displaying the user interface element with the first appearance indicating that the computer system will not be stationary within a first predetermined period of time and displaying the user interface element (e.g., 610) with the second visual appearance indicating that the computer system will be stationary within the first predetermined period of time provides the user with feedback concerning the state of the computer system, which provide improved visual feedback.

In some embodiments, the representation of the subject includes a first amount of physical features of the subject, and wherein the data includes a second amount of physical features of the subject that is greater than the first amount. In some embodiments, the representation of the subject indicates the size of the subject and the speed of movement of the subject. However, in some embodiments, the representation of the subject does not include one or more facial features and/or physical features of the subject. In some embodiments, the representation of the subject is a blob. In some embodiments, one more immutable characteristics of the subject cannot be determined from looking at the representation of the subject. Displaying the representation of the subject when prescribed conditions are met allows computer system to display information concerning the state of the computer system when deemed appropriate, which performs an operation when a set of conditions has been met without requiring further user input and provides improved feedback to the user and provide improved feedback to the user.

In some embodiments, in accordance with a determination that the first set of criteria is not met and before displaying the user interface element (e.g., 610) with the second appearance, the computer system transitions an appearance of the user interface element (e.g., 610) from the first appearance to the second appearance, wherein the transitioning includes decreasing (e.g., gradually decreasing and/or decreasing based on the rate of change in the movement of the computer system) an amount of a characteristic (e.g., a visual characteristic, a color, light, brightness, and/or size of an indicator) of the user interface element that is displayed with the first appearance (e.g., over a first period of time). Decreasing the amount of the characteristic of the user interface element that is displayed accordance with a determination that the first set of criteria is not met allows the computer system to automatically provide a dynamic indication that informs a person how the computer system is moving, which provides improved visual feedback and performs an operation when a set of conditions has been met without requiring further user input and provides improved feedback to the user and provide improved feedback to the user.

In some embodiments, while displaying the user interface element (e.g., 610) with the second appearance and in accordance with a determination that the first set of criteria is met, the computer system transitions an appearance of the user interface element from the second appearance to the first appearance, where the transitioning includes increasing an amount of the characteristic of the user interface element that is displayed with the second appearance over a second period of time. In some embodiments, while displaying the user interface element with the second appearance and in accordance with a determination that the first set of criteria is met, the computer system displays, via the display generation, the user interface element with the first appearance and ceases display of the user interface element with the second appearance, wherein displaying the user interface element with the first appearance. Increasing an amount of the characteristic of the user interface element that is displayed with the second appearance over a second period of time in accordance with a determination that the first set of criteria is met allows the computer system to automatically provide a dynamic indication that informs a person how the computer system is moving, which provides improved visual feedback and performs an operation when a set of conditions has been met without requiring further user input and provides improved feedback to the user and provide improved feedback to the user.

In some embodiments, displaying, via the display generation component, the representation of the subject includes: in accordance with a determination that the subject is moving in a first direction, moving the representation of the subject in the first direction; and in accordance with a determination that the subject is moving in a second direction that is different from the first direction, moving the representation of the subject in the second direction. In some embodiments, while displaying the representation of the subject, displaying a second representation of a second subject, where the second representation is moved based on movement of the second subject (e.g., the second representation is not displayed based on movement of the subject; the representation is not displayed based on movement of the second subject). Moving a representation of the subject based on the subject's movement provides the subject with visual feedback that they are within a certain proximity of the computer system, which provides improved visual feedback and performs an operation when a set of conditions has been met without requiring further user input.

In some embodiments, in accordance with a determination that the subject is a first size, the representation of the subject is a second size (e.g., a size that is based on the first size and not based on a second size that is different from the first size); and in accordance with a determination that the subject is a third size that is different from the first size, the representation of the subject is fourth size that is different form the second size (e.g., a size that is based on the third size and not based on the first size). Displaying a representation of the subject at a size based on the size of the subject provides the subject dynamic visual feedback that they are within a certain proximity of the computer system, which provides improved visual feedback and performs an operation when a set of conditions has been met without requiring further user input.

In some embodiments, in accordance with a determination that the subject is a first distance (and/or proximity) from the computer system, the representation of the subject is a fifth size; and in accordance with a determination that the subject is a second distance from the computer system, the representation of the subject is a sixth size that is different from the fifth size, wherein the second distance is different from the first distance. Displaying a representation of the subject at a size based on the distance that the subject is from the computer system provides the subject with dynamic visual feedback that they are within a certain proximity of the computer system, which provides improved visual feedback and performs an operation when a set of conditions has been met without requiring further user input.

In some embodiments, the representation of the subject is not displayed until the user interface element (e.g., 610) is displayed with the second appearance. In some embodiments, while displaying the representation of the subject concurrently with the user interface element with the second appearance, the computer system detects a change in movement of the computer; and in response, ceases to display the representation of the subject and ceases to display the user interface element with the second appearance.

In some embodiments, the representation of the subject is displayed concurrently with the user interface element with the second appearance, and wherein the representation of the subject is not displayed concurrently with the user interface element with the first appearance.

In some embodiments, the first set of criteria includes a determination that is made that the computer system will not be stationary within a second predetermined period of time (e.g., within 0-5 minutes) (e.g., the computer system is moving for and/or will be moving within the first predetermined period of time or after the predetermined period of the time has passed). Displaying the representation of the subject when a determination that is made that the computer system will not be stationary within a second predetermined period of time allows computer system to display information concerning the state of the computer system when deemed appropriate, which performs an operation when a set of conditions has been met without requiring further user input and provides improved feedback to the user and provide improved feedback to the user.

In some embodiments, the representation of the subject is displayed concurrently with the user interface element with the second appearance; displaying the user interface element (e.g., 610) with the first appearance includes displaying, via the display generation component, a first portion of a user interface with a first visual characteristic (e.g., 612) and a second portion of the user interface element with the first visual characteristic; and displaying the user interface element (e.g., 610) with the second appearance includes displaying, via the display generation component, the first portion of the user interface element with the first visual characteristic (e.g., 612) and the second portion of the user interface element with a second visual characteristic that is different from the first visual characteristic.

In some embodiments, the computer system is in communication with a speaker. In some embodiments, in conjunction with (e.g., while, within a predetermined period of time (e.g., 1-30 seconds) after, within the predetermined period of time before) displaying the user interface element (e.g., 610) with second appearance and in accordance with a determination that the first set of criteria is not met, the computer system outputs, via one or more speakers, a first sound that changes based on a rate (e.g., a speed of movement) of movement (e.g., a non-zero rate) of the computer system. In some embodiments, in accordance with a determination that movement of the computer system is changing at a first rate, the pitch, tone, and/or volume of the sound go up (or goes down) at a second rate. In some embodiments, in accordance with a determination that movement of the computer system is changing at a third rate that is different form the first rate, the pitch, tone, and/or volume of the sound go up (or goes down) at a fourth rate that is different from the second rate. Outputting a first sound that changes based on a rate (e.g., a speed of movement) of movement (e.g., a non-zero rate) of the computer system provides the user with feedback concerning how the computer system is moving and/or will be moving in the future in the physical environment, which provide feedback to the user.

In some embodiments, the computer system: in accordance with a determination that the first set of criteria is met while displaying the user interface element with the second appearance, transitions an appearance of the user interface element from the second appearance to the first appearance; and in conjunction with transitioning the user interface element to the first appearance, outputs, via the one or more speakers, a second sound that does not change based on the rate of movement of the computer system, wherein the second sound is different from the first sound. In some embodiments, when the first sound goes up in pitch, tone, and/or volume, the second sound goes down in pitch, tone, and/or volume over a period of time. In some embodiments, when the first sound goes down in pitch, tone, and/or volume, the second sound goes up in pitch, tone, and/or volume over the period of time. Outputting the second sound that does not change based on the rate of the computer system informs a subject that the computer system is starting and/or will be starting to be caused to move, which provide feedback to the user

In some embodiments, in conjunction with transitioning the user interface element (e.g., 610) to the first appearance and before outputting the second sound, the computer system outputs, via the display generation component, a third sound that does not change based on the rate of movement of the computer system, wherein the third sound is different from the first sound and the second sound.

In some embodiments, before displaying the user interface element (e.g., 610) with the second appearance, the computer system transitions an appearance of the user interface element from the first appearance to the second appearance, where the transitioning includes displaying a first animation that transitions from display of the user interface element with the first appearance to display of the user interface element with the second appearance, and wherein a movement rate (e.g., how fast the animation takes place and/or the speed of the animation from start to finish) of the transitioning to the second appearance is based on the movement of the computer system (e.g., while displaying the first animation). In some embodiments, in accordance with a determination that movement of the computer system is decreasing by a first rate, the first animation has a second speed and/or a first display rate; and in accordance with a determination that movement of the computer system is decreasing by a third rate that is different from the first rate, the first animation has a fourth rate and/or a second display rate.

In some embodiments, in accordance with a determination that the first set of criteria is met while displaying the user interface element with the second appearance, the computer system transitions an appearance of the user interface element from the second appearance to the first appearance, where a movement rate of the transitioning to the first appearance is not based on the movement of the computer system. In some embodiments, the movement rate of the second animation is the same irrespective of the movement of the computer system. In some embodiments, the computer system is caused to be raised in conjunction with displaying the second animation (e.g., as described below in relation to method 1100).

Note that details of the processes described above with respect to method 700 (e.g., FIG. 7) are also applicable in an analogous manner to the methods described below. For example, method 800 optionally includes one or more of the characteristics of the various methods described above with reference to method 700. For example, the first set of criteria of method 700 are not met when operations of method 800 are performed. For brevity, these details are not repeated below.

FIG. 8 is a flow diagram illustrating a method for indicating awareness of a subject using a computer system in accordance with some embodiments. Method 800 is performed at a computer system (e.g., 100, 300, 500, and/or 600) that is in communication with a display generation component (e.g., display screen and/or a touch-sensitive display) and one or more sensors (e.g., one or more telephoto, wide angle, and/or ultra-wide-angle cameras) and/or one or more sensors (e.g., temperature, lidar, radar, and/or motion). In some embodiments, the computer system is a watch, a fitness tracking device, a phone, a tablet, a processor, a head-mounted display (HMD) device, and/or a personal computing device. Some operations in method 800 are, optionally, combined, the orders of some operations are, optionally, changed, and some operations are, optionally, omitted.

As described below, method 800 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 810 of method 800, the computer system detects, via the one or more sensors, data corresponding to a subject (e.g., a person and/or an animal) (and, in some embodiments, not an object) in an environment (e.g., as described above in relation to method 700).

At 820 of method 800, the computer system in response to detecting the data corresponding to the subject and in accordance with a determination that the subject meets a respective set of criteria, wherein the respective set of criteria includes a criterion that is met when a determination is made that the subject is within a predetermined distance from the computer system, displays, via the display generation component, a user interface (e.g., that was not previously displayed before the subject was detected in the field of-view of the one or more cameras) that indicates awareness of the subject, including a first user interface object (e.g., that moves based on movement of the subject) that has a visual appearance (e.g., at least one visual characteristic) (e.g., size and/or shape) that is based on the visual appearance of the subject (e.g., representation of the subject, as described above in relation to method 700); and

At 830 of method 800, the computer system in response to detecting the data corresponding to the subject and in accordance with a determination that the subject does not meet the respective set of criteria, forgoes displaying the first user interface object. In some embodiments, the first user interface object is not a part of the field-of-view and/or detection of the sensor and/or an actual representation of the field-of-view and/or detection of the sensor. In some embodiments, the first user interface object is not displayed with a representation of the physical environment and/or portions of the physical environment that are not subjects. Dynamically displaying the first user interface object based on prescribed conditions provides the user with feedback about the state of the computer system, which provides improved visual feedback and performs an operation when a set of conditions has been met without requiring further user input.

In some embodiments, in response to detecting the data corresponding to the subject, the computer system: in accordance with a determination that the subject is within a third area (e.g., an area in front of the computer system and/or an area in front of the display generation component) and within a predetermined distance from the computer system, displays the first user interface object (e.g., 614 and/or 616); and in accordance with a determination that the subject is within the third area and not within a predetermined distance from the computer system, forgoing displaying the first user interface object. Displaying the first object user interface object based on the distance between a subject and the computer system provides improved visual feedback and performs an operation when a set of conditions has been met without requiring further user input.

In some embodiments, the first user interface object (e.g., 614 and/or 616) is displayed with an indication that the computer system is not moving (e.g., and/or will not move within a predetermined period of time) (e.g., user interface element with the second appearance, as described above in relation to method 700). Displaying a first user interface object to indicate that the computer system is not moving provides improved visual feedback and performs an operation when a set of conditions has been met without requiring further user input.

In some embodiments, displaying the first user interface object (e.g., 614 and/or 616) includes: in accordance with a determination that the subject is moving in a first direction in the environment, moving the first user interface object in a second direction (e.g., as described above in relation to method 700); and in accordance with a determination that the subject is moving in a third direction in the environment, moving the first user interface object in a fourth direction that is different from the second direction, wherein the third direction is different form the first direction e.g., as described above in relation to method 700). Moving the first user interface object based on the direction of a subject in the environment provides improved visual feedback and performs an operation when a set of conditions has been met without requiring further user input.

In some embodiments, the set of criteria includes a criterion that is met when the subject is a first type of subject (e.g., person or animal), and where the set of criteria includes a criterion that is not met when the subject is a second type of subject different from the first type of subject (e.g., not a person or animal). In some embodiments, the set of criteria includes a criterion that is not met when the subject is an object (e.g., a building, an electronic device, and/or another computer system).

In some embodiments, while displaying the first user interface object (e.g., 614 and/or 616), the computer system detects, via the one or more sensors, data corresponding to a second subject that is different from the subject; and in response to data corresponding the second subject: in accordance with a determination that the subject and the second subject meet the set of criteria, displays, via the display generation component, a second user interface object that has a visual appearance that is based on the visual appearance of the second subject (and not the subject), wherein the second user interface is displayed concurrently with the first user interface object (e.g., as described above in relation to method 700). In some embodiments, in accordance with a determination that the subject meets the set of criteria and the second subject does not meet the set of criteria, displaying the first user interface object without displaying the second user interface object. In some embodiments, in accordance with a determination that the subject does not meet the set of the criteria and the second subject meets the set of criteria, displaying the second user interface object without display the first user interface object. In some embodiments, in accordance with a determination that the subject and the second subject do not meet the set of criteria, the computer system forgoes displaying the first user interface object and the second user interface object

In some embodiments, while displaying the first user interface object and the second user interface object: in accordance with a determination that the subject and the second subject meet the set of criteria and in accordance with a determination that the subject is closer to the computer system than the second subject, displaying the first user interface element at least partially on top of the second user interface object (e.g., a size of the first user interface object is greater than (or bigger than) a size of the second user interface object); and in accordance with a determination that the subject and the second subject meet the set of criteria and in accordance with a determination that the second subject is closer to the computer system than the subject, displaying the second user interface element at least partially on top of the user interface object (e.g., the size of the second user interface object is greater than the size of the first user interface object). Displaying the second user interface element at least partially on top of the user interface object dynamically provides feedback about the state of the device and physical environment concurrently via one user interface, which provides improved visual feedback and performs an operation when a set of conditions has been met without requiring further user input.

In some embodiments, the first user interface object is displayed with a respective visual characteristic (e.g., 612) (e.g., a color, brightness, hue, and/or tint), and the second user interface object is displayed with the respective visual characteristic (e.g., the color, brightness, hue, and/or tint) (e.g., the representation of the subject, as described above in relation to method 700).

In some embodiments, while displaying the first user interface object and the second user interface object, the computer system detects movement of one or more of the subject and the second subject; and in response to detecting movement of one or more of the subject and the second subject: in accordance with a determination that the subject is within a third area relative (e.g., directionally relative to and/or positionally relative to) to the computer system (e.g., an area that is in front of the computer system) and the second subject is within a fourth area relative to the computer system (e.g., an area that is in behind the computer system), where the fourth area is different form the third area, and wherein the fourth area and the third area are within the predetermined distance from the computer system (e.g., away from the middle portion, middle point, centroid, center of the computer system), continuous to display the first user interface object without displaying the second user interface object; and in accordance with a determination that the second subject is within the third area relative to the computer system and the subject within the fourth area relative to the computer system, continuous to display the second user interface object without displaying the first user interface object. In some embodiments, in accordance with a determination that the subject and the second subject are in the third area relative to the computer system, the computer system continues to display the first user interface object and the second user interface object. In some embodiments, in accordance with a determination that the subject and the second subject are in the fourth area relative to the computer system, the computer system ceases to display the first and second user interface objects.

Note that details of the processes described above with respect to method 800 (e.g., FIG. 8) are also applicable in an analogous manner to the methods described above and below. For example, method 900 optionally includes one or more of the characteristics of the various methods described above with reference to method 800. For example, the second user interface of method 1100 can includes the first user interface object of method 800. For brevity, these details are not repeated.

FIG. 9 is a flow diagram illustrating a method for indicating acceleration using a computer system in accordance with some embodiments. Method 900 is performed at a computer system (e.g., 100, 300, 500, and/or 600) that is in communication with a display generation component (e.g., display screen and/or a touch-sensitive display). In some embodiments, the computer system is a watch, a fitness tracking device, a phone, a tablet, a processor, a head-mounted display (HMD) device, and/or a personal computing device. In some embodiments, the computer system is in communication with one or more cameras (e.g., one or more telephoto, wide angle, and/or ultra-wide-angle cameras). Some operations in method 900 are, optionally, combined, the orders of some operations are, optionally, changed, and some operations are, optionally, omitted.

As described below, method 900 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 910 of method 900, the computer system, while displaying, via display generation, a respective user interface with an amount of a visual characteristic (e.g., brightness, color, and/or visual characteristics, as described above in relation to method 700), detects the occurrence of a respective set of movement conditions.

At 920 of method 900, the computer system, in response to detecting the occurrence of the respective set of movement conditions and in accordance with a determination that the respective set of movement conditions is a first set of movement conditions (e.g., a deceleration condition (e.g., deceleration, where the current speed is below a certain threshold and/or where the rate of deceleration is above a certain threshold) and/or a condition that the computer system will be stationary within a predetermined period of time) (e.g., based on a predetermined route and/or decision to stop moving) (e.g., that the computer system will stop moving within a predetermined period of time) (e.g., computer system will transition from a non-stationary state to a stationary state within a predetermined period of time), changes (e.g., adjusting and/or increasing an amount of color (e.g., black and/or a dark color) that is filling display and/or decreasing the amount of a color) (e.g., decreasing an amount of brightness) (e.g., while the computer system is moving) the amount of the visual characteristic relative to (e.g., with a speed of change that is based on and/or with a speed of change that is the same as) a rate (e.g., the lateral speed, backward speed, and/or the forward speed, a speed of the computer system traversing (e.g., the ground and/or a surface in) the physical environment) of movement of the computer system (e.g., as described above in relation to method 700).

At 930 of method 900, the computer system, in response to detecting the occurrence of the respective set of movement conditions and in accordance with a determination that the respective set of movement conditions is a second set of movement conditions that is different from the first set of movement conditions (e.g., an acceleration condition and/or a condition that a determination is made the computer system will not be stationary within a predetermined period of time) (e.g., based on a predetermined route and/or decision to start moving) (e.g., that the computer system will start moving within a predetermined period of time) (e.g., computer system will transition from a stationary state to a non-stationary state within a predetermined period of time), changing the amount of the visual characteristic (e.g., while the computer system is moving and/or before the computer system has started moving) (e.g., adjusting and/or decreasing an amount (e.g., black and/or a dark color) of color that is filling display and/or decreasing the amount of a color) (e.g., increasing an amount of brightness) relative to a respective rate (e.g., a predetermined rate and/or a predefined rate) that is different from the rate of movement of the computer system (e.g., without changing the indication relative to the rate of movement of the computer system) (e.g., as described above in relation to method 700). Changing the amount of the visual characteristic different based on prescribed conditions allow the computer system to inform subjects concerning the state of the computer system at a point in time, which provides improved visual feedback and performs an operation when a set of conditions has been met without requiring further user input.

In some embodiments, before detecting the occurrence of the respective set of the movement conditions, the amount of the visual characteristic (e.g., 612) is a first amount; and after the amount of the visual characteristic (e.g., 612) is changed relative to the respective rate, the amount of the visual characteristic is a second amount that is different from the first amount. In some embodiments, while the amount of the visual characteristic is the second amount, detecting the occurrence of a third set of movement conditions (e.g., different from the respective set of movement conditions); and in response to detecting the occurrence of the third set of movement conditions: in accordance with a determination that the third set of movement conditions is the first set of movement conditions, the computer system changes the amount of the visual characteristic (e.g., 612) relative to the rate of movement of the computer system (e.g., 600), wherein, after changing the amount of the visual characteristic relative to the rate of movement of the computer system, the amount of the visual characteristic is the first amount (e.g., as described above in relation to method 700). In some embodiments, in accordance with a determination that the third set of movement conditions is not the first set of movement conditions, the computer system does not change the amount of the visual characteristic relative to the rate of movement of the computer system and/or the amount of the visual characteristic continues to be the second amount.

In some embodiments, before detecting the occurrence of the respective set of movement conditions, the amount of the visual characteristic (e.g., 612) is a third amount; and after the amount of the visual characteristic (e.g., 612) is changed relative to the rate of movement of the computer system, the amount of the visual characteristic is a fourth amount that is different from the third amount. In some embodiments, the computer system while the amount of the visual characteristic is the fourth amount, detects the occurrence of a fourth set of movement conditions (e.g., different from the respective set of movement conditions); and in response to detecting the occurrence of the fourth set of movement conditions: in accordance with a determination that the fourth set of movement conditions is the second set of movement conditions, changes the amount of the visual characteristic relative to the respective rate, where, after changing the amount of the visual characteristic relative to the rate of movement of the computer system, the amount of the visual characteristic is the third amount (e.g., as described above in relation to methods 700 and 800). In some embodiments, in accordance with a determination that the fourth set of movement conditions is not the second set of movement conditions, the computer system does not change the amount of the visual characteristic relative to the respective and/or the amount of the visual characteristic continues to be the fourth amount.

In some embodiments, the computer system changes the amount of the visual characteristic (e.g., 612) relative to the respective rate indicates that a determination has been made the computer system will not be stationary within a first predetermined period of time (e.g., as described above in relation to method 700), and wherein changing the amount of the visual characteristic relative to the respective rate indicates that the computer system will be stationary within the first predetermined period of time (e.g., as described above in relation to method 700). In some embodiments, the respective rate is faster than the rate of the movement of the computer system.

In some embodiments, before the computer s32ystem is caused to be moved, the amount of the visual characteristic is changed relative to the respective rate occurs (and not relative to the rate of the movement of the computer system occurs). In some embodiments, before the computer system is caused to stop moving, the amount of the visual characteristic (e.g., 612) is changed relative to the rate of the movement of the computer system occurs (and not relative to the respective rate).

In some embodiments, the first set of movement conditions includes a condition that is met when a determination is made that the computer system will be stationary within a second predetermined period of time (e.g., as described above in relation to method 700). In some embodiments, the second set of movement conditions include a condition that is met when a determination is made that the computer system will not be stationary within a third predetermined period of time (e.g., as described above in relation to method 700).

In some embodiments, changing the amount of the visual characteristic includes adjusting (e.g., increasing and/or decreasing) a brightness (and/or amount of light output by the display generation component) of the respective user interface. In some embodiments, changing the amount of the visual characteristic (e.g., 612) includes increasing or decreasing (e.g., via the display generation component) the amount of a color of the respective user interface. In some embodiments, changing the amount of the visual characteristic relative to the rate of movement of the computer system includes decreasing the amount of color and/or brightness of the respective user interface relative to the rate of movement of the computer system.

In some embodiments, changing the amount of the visual characteristic relative to the respective rate that is different from the rate of movement of the computer system includes increasing the amount of color and/or brightness of the respective user interface relative to the respective rate.

In some embodiments, before changing the amount of the visual characteristic (e.g., 612) relative to the rate of movement of the computer system, the amount of the visual characteristic is a fifth amount; and after changing the amount of the visual characteristic relative to the rate of movement of the computer system, the amount of the visual characteristic is a sixth amount that is different from the fifth amount, wherein the sixth amount and the fifth amount are not zero.

In some embodiments, the first set of movement conditions includes a condition that the computer system will be deaccelerating within a fourth predetermined period of time (e.g., as described above in relation to method 700), and wherein the second set of movement conditions includes a condition that the computer system will be accelerating within a fifth predetermined period of time (e.g., as described above in relation to method 700).

Note that details of the processes described above with respect to method 900 (e.g., FIG. 9) are also applicable in an analogous manner to the methods described above and below. For example, method 1100 optionally includes one or more of the characteristics of the various methods described above with reference to method 900. For example, the respective set of movement conditions of method 900 can include the occurrence of the condition of method 1100. For brevity, these details are not repeated.

FIG. 10 is a flow diagram illustrating a method for indicating movement of a computer system in accordance with some embodiments. Method 1000 is performed at a computer system (e.g., 100, 300, 500, and/or 600) that is in communication with a display generation component (e.g., display screen and/or a touch-sensitive display). In some embodiments, the computer system is in communication with one or more cameras (e.g., one or more telephoto, wide angle, and/or ultra-wide-angle cameras). In some embodiments, the computer system is a watch, a fitness tracking device, a phone, a tablet, a processor, a head-mounted display (HMD) device, and/or a personal computing device. Some operations in method 1000 are, optionally, combined, the orders of some operations are, optionally, changed, and some operations are, optionally, omitted.

As described below, method 1000 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 1010 of method 1000, the computer system displays, via the display generation component, a user interface that includes an indication that is displayed within (e.g., covering, and/or is overlaying on) a first portion of a display area (e.g., of the display generation component and/or an area of a display on which the display generation component is projecting on to) and a second portion of the display area, wherein the first portion is different from (e.g., separate from, does not encompass, is not encompassed by, and/or includes) the second portion (e.g., without displaying multiple instances of the indication).

At 1020 of method 1000, the computer system, while displaying, via the display generation component, the user interface that includes the indication that covers the first portion and the second portion (e.g., a portion of the indication is included in the first portion and a different portion of the indication is included in the second portion) and while the computer system is in a non-stationary state (e.g., while the computer system is moving), detects a change in a movement condition (e.g., a speed and/or acceleration of the computer system).

At 1030 of method 1000, the computer system, in response to detecting the change in the movement condition (e.g., a stopping movement condition, as described above in relation to method 900) and in accordance with a determination that the computer system is transitioning from the non-stationary state to a stationary state, changes, via the display generation component, (e.g., adjusting, shrinking, decreasing the size of, and/or removing a part of) the indication so that the indication is displayed within the first portion without being displayed within in the second portion. In some embodiments, in response to detecting the change in movement condition and in accordance with a determination that the computer system is not transitioning from the non-stationary state to the stationary state, the computer system does not change the indication and continues to include the indication in the first portion and the second portion.

In some embodiments, the first portion does not overlap (e.g., and/or is not overlaid on and/or over, does not encompass, and/or is not encompassed by) the second portion. In some embodiments, the first portion is adjacent to the second portion. In some embodiments, the first portion and the second portion are connected and/or are continuous.

In some embodiments, changing the indication so that the indication is displayed within the first portion without being displayed within in the second portion includes removing, via the display generation component, a first visual characteristic (e.g., 612) (e.g., color, light, brightness, and/or tone) from the second portion (e.g., over a period of time and/or over a period of time based on the movement of the computer system) (e.g., as described above in relation to methods 700-900).

In some embodiments, removing the first visual characteristic includes: in accordance with a determination that movement of the computer system is changing in a respective manner (e.g., increasing or decreasing) at a first rate, ceasing display of the first visual characteristic (e.g., corresponding to the indication and/or the indication) from the second portion at a second rate (e.g., as described above in relation to methods 700-900); and in accordance with a determination that movement of the computer system is changing in a respective manner (e.g., increasing or decreasing) at a third rate that is different form the first rate, ceasing display of (e.g., like removing water from a glass) first visual characteristic (e.g., corresponding to the indication and/or the indication) from the second portion at a fourth rate that is different from the second rate (e.g., as described above in relation to methods 700-900).

In some embodiments, the computer system is in communication with one or more sensors. In some embodiments, while the indication (e.g., 612) is changed such that the indication is displayed within the first portion without being displayed within in the second portion, the computer system detects, via the one or more sensors, data that includes a subject in an environment (e.g., in a physical environment or a virtual environment); and in response to detecting data that includes the subject, the computer system displays, via the display generation component, a representation (e.g., 614 and/or 616) of the subject within the second portion while the indication continues to be displayed within the first portion (e.g., as described above in relation to methods 700-900).

In some embodiments, displaying, via the display generation component, the representation of the subject includes: in accordance with a determination that the subject has moved in the environment in a first direction, moving the representation of the subject in a third direction (e.g., as described above in relation to methods 700-900); and in accordance with a determination that the subject has moved in the environment in a second direction that is different from the first direction, moving the representation of the subject in a fourth direction that is different from the third direction (e.g., as described above in relation to methods 700-900).

In some embodiments, the representation of the subject does not cover the entirety of the second portion. In some embodiments, the indication does not cover the second subject.

In some embodiments, the representation of the subject has a second visual characteristic, and wherein the indication displayed within the first portion has the second visual characteristic (e.g., as described above in relation to methods 700-900). In some embodiments, except for the subject and without the indication within the respective portion, the first portion does not have the second visual characteristic. In some embodiments, the second portion has the second visual characteristic.

In some embodiments, while the indication is displayed within the first portion without being displayed within in the second portion: the first portion has a third visual characteristic; and the second portion has a fourth visual characteristic that is different from the third visual characteristic.

Note that details of the processes described above with respect to method 1000 (e.g., FIG. 10) are also applicable in an analogous manner to the methods described above and below. For example, method 700 optionally includes one or more of the characteristics of the various methods described above with reference to method 1000. For example, the user interface of method 1000 can be the respective user interface of method 700. For brevity, these details are not repeated.

FIG. 11 is a flow diagram illustrating a method for indicating no movement using a computer system in accordance with some embodiments. Method 1100 is performed at a computer system (e.g., 100, 300, 500, and/or 600) that is in communication with a display generation component (e.g., display screen and/or a touch-sensitive display). In some embodiments, the computer system is in communication with one or more cameras (e.g., one or more telephoto, wide angle, and/or ultra-wide angle cameras) and a physical mechanism (e.g., an actuator, a level, an arm, a suspension system, an a hydraulic lift, and/or a lift): In some embodiments, the computer system is a watch, a fitness tracking device, a phone, a tablet, a processor, a head-mounted display (HMD) device, and/or a personal computing device. Some operations in method 1100 are, optionally, combined, the orders of some operations are, optionally, changed, and some operations are, optionally, omitted.

As described below, method 1100 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 1110 of method 1100, the computer system displays, via the display generation component, a first user interface.

At 1120 of method 1100, the computer system, while displaying the first user interface, detecting an occurrence of a condition (e.g., physical entity within a certain proximity of the computer system, a movement condition, such as the computer system is determined to be starting and/or moving within a predetermined period of time and/or the computer system has started and/or has moved) (e.g., a stopping movement condition, as described above in relation to method 900).

At 1130 of method 1100, the computer system, in response to detecting the occurrence of the condition, displays, via the display generation component, a second user interface that is different from the first user interface (e.g., and was not displayed before the occurrence of the condition was detected). In some embodiments, the second user interface is darker and/or dimmer than the first user interface. In some embodiments, the second user interface includes a portion of the first user interface and the first user interface does not include a portion of the second user interface. In some embodiments, displaying the second user interface includes displaying an animation of the first user interface filling up with a color (e.g., black, yellow, and/or white) and/or gradually decreasing the amount of brightness of the first user interface to display the second user interface with less brightness) (e.g., as described above in relation to methods 700-900). and

At 1140 of method 1100, the computer system, in response to detecting the occurrence of the condition, causing the physical mechanism to lower the computer system (e.g., lowering, via the physical mechanism, the computer system). In some embodiments, in response to detecting an occurrence of a second condition that is different from the occurrence of the condition, forgoing causing the physical mechanism to lower the computer system. Updating different user interfaces based on particular conditions occurring allows a user to be up to date on what is happening with the computer system, reducing the number of inputs needed to perform an operation. Displaying a first user interface element based on movement of a computer system that is at least partially circumscribed by a second user interface element displayed based on occurrence of events provides information that traditionally required several user inputs, which reduces the number of inputs needed to perform an operation.

In some embodiments, causing the physical mechanism to lower the computer system includes sending instructions that causes the physical mechanism to lower one or more portions of the computer system. In some embodiments, one or more portions of the computer system are not lowered. Sending an instruction to cause the physical mechanism to lower allows for the computer system to not have to spend processing time while lowering and instead can leave those operations to the mechanism to which the instruction is sent, ensuring additional efficiency.

In some embodiments, displaying, via the display generation component, the second user interface includes removing a visual characteristic from a first portion of the first user interface while continuing to display the visual characteristic on a second portion of the user interface, wherein the first portion is different from (e.g., separate from, distinct from, not encompassed by, and/or does not encompass) the second portion. Removing visual characteristics while continuing to display a visual characteristic ensures that others can identify that the computer system is still running and not turned off, providing improved visual feedback to the user and performing an operation when a set of conditions has been met without requiring further user input.

In some embodiments, displaying, via the display generation component, the second user interface includes displaying a first animation that transitions from display of the first user interface to display of the second user interface (e.g., the user interface element, as described above in relation to method 700), and wherein the first animation is displayed while causing the physical mechanism to lower the computer system. Outputting an animation while lowering allows for others to be aware of movements in the environment, providing improved visual feedback to the user and performing an operation when a set of conditions has been met without requiring further user input.

In some embodiments, displaying, via the display generation component, the second user interface includes displaying a second animation that transitions from display of the first user interface to display of the second user interface (e.g., the user interface element, as described above in relation to method 700). In some embodiments, the first animation is displayed before causing the physical mechanism to lower the computer system. Outputting an animation before lowering allows for others to be aware of movements in the environment, providing improved visual feedback to the user and performing an operation when a set of conditions has been met without requiring further user input.

In some embodiments, detecting the occurrence of the condition includes detecting that the computer system will not be moving within a predetermined period of time. Keying the occurrence of a condition on whether the computer system will not be moving within a predetermined period of time ensures that the computer system is communicating its movements, providing improved visual feedback to the user and performing an operation when a set of conditions has been met without requiring further user input.

In some embodiments, while causing the physical mechanism to lower the computer system and while displaying the second user interface, detects an occurrence of a second condition that is different from the condition. In some embodiments, in response to detecting the occurrence of the second condition, the computer system displays, via the display generation component, the first user interface (e.g., without displaying the second user interface) (e.g., the user interface element, as described above in relation to method 700); and causes the physical mechanism to raise the computer system. Raising the computer system when an event occurs allows for the computer system to be reactive, providing improved visual feedback to the user and performing an operation when a set of conditions has been met without requiring further user input.

In some embodiments, displaying the first user interface in response to detecting the occurrence of the second condition includes adding a second visual characteristic to a third portion of the first user interface while continuing to display the second visual characteristic (e.g., the same amount of color before the device went from the non-stationary state to the stationary state) on a fourth portion of the user interface (e.g., the user interface element, as described above in relation to method 700), and wherein the third portion is different from the fourth portion. Displaying an additional visual characteristic when a condition occurs ensures that the condition is known, providing improved visual feedback to the user and performing an operation when a set of conditions has been met without requiring further user input.

In some embodiments, displaying the first user interface in response to detecting the occurrence of the second condition includes displaying a third animation that transitions from display of the second user interface to display of the first user interface (e.g., the user interface element, as described above in relation method 700), and wherein the third animation is displayed while causing the physical mechanism to raise the computer system (and, in some embodiments, the device is caused to stop raising before the user interface has stopped changing to being displayed with more color). Displaying an animation when causing the physical mechanism to raise the computer system provides a visual cue to others that something is occurring with the computer system, providing improved visual feedback to the user and performing an operation when a set of conditions has been met without requiring further user input.

In some embodiments, the computer system is in communication with one or more speakers. In some embodiments, in conjunction with (e.g., after, within a predetermined period of time before, and/or within the predetermined period of time after) causes the computer system to be lowered, outputting, via the one or more speakers, a first sound; and in conjunction with causing the device to be raised, outputting, via the one or more speakers, a second sound that is different from the first sound. Outputting sounds while lowering allows for other to be aware of movements in the environment, providing improved visual feedback to the user and performing an operation when a set of conditions has been met without requiring further user input.

In some embodiments, the first user interface includes a third visual characteristic and a fourth visual characteristic, and wherein the second user interface includes the third visual characteristic and does not include the fourth visual characteristic (and, in some embodiments, the first user interface and/or the second user interface has only two colors). Ensuring that the first user interface includes multiple colors allows for output to distinguish using different colors, reducing the number of inputs needed to perform an operation.

Note that details of the processes described above with respect to method 1100 (e.g., FIG. 11) are also applicable in an analogous manner to the methods described above and below. For example, method 1200 optionally includes one or more of the characteristics of the various methods described above with reference to method 1100. For example, the second user interface element of method 1200 can be concurrently displayed with the first user interface element of method 1100. For brevity, these details are not repeated.

FIG. 12 is a flow diagram illustrating a method for indicating movement information using a computer system in accordance with some embodiments. Method 1200 is performed at a computer system (e.g., 100, 300, 500, and/or 600) that is in communication with a first display generation and a second display generation component (e.g., display screen and/or a touch-sensitive display). In some embodiments, the computer system is in communication with one or more sensors (e.g., one or more cameras (e.g., one or more telephoto, wide angle, and/or ultra-wide-angle cameras), one or more radar sensors, and/or one or more lidar sensors). In some embodiments, the computer system is a watch, a fitness tracking device, a phone, a tablet, a processor, a head-mounted display (HMD) device, and/or a personal computing device. Some operations in method 1200 are, optionally, combined, the orders of some operations are, optionally, changed, and some operations are, optionally, omitted.

As described below, method 1200 provides an intuitive way for indicating movement. The method reduces the cognitive burden on a user for indicating movement, thereby creating a more efficient human-machine interface. For battery-operated computing devices, enabling a user to indicate movement faster and more efficiently conserves power and increases the time between battery charges.

At 1210 of method 1200, the computer system, while the computer system is moving, displays, via the first display generation component, a first user interface element with a first appearance (e.g., with or without displaying a user interface element via the second display generation component).

At 1220 of method 1200, the computer system, while displaying the first user interface element with the first appearance (e.g., as described above in relation to the user interface element and/or representation of the subject and method 700), detects occurrence of one or more events; and

At 1230 of method 1200, the computer system, in response to detecting the occurrence of the one or more events and in accordance with a determination that the one or more events include a first event, wherein the first event is detected when a determination is made that the computer system is moving, continues to display the first user interface element (e.g., a representation and/or indication of information (e.g., whether the computer system is moving, not moving, starting movement, and/or stopping movement) that indication a decision that is determined based on the current directional movement of the computer system) with the first appearance.

At 1240 of method 1200, the computer system in response to detecting the occurrence of the one or more events and in accordance with a determination that the one or more events does not include the first event, displays, via the first display generation component, the first user interface element with a second appearance that is different from the first appearance.

At 1250 of method 1200, the computer system, in response to detecting the occurrence of the one or more events and in accordance with a determination that the one or more events includes a second event that is a different type of event than the first event, displays, via a second display generation component, a second user interface element (e.g., a representation of second user interface element (e.g., turning right, turning left, and/or hazard) that indicates a decision that is not determined based on current directional movement (e.g., some movement and/or no movement and/or lateral movement and/or movement along a route) of the computer system) that at least partially circumscribes the first user interface element.

At 1260 of method 1200, the computer system, in response to detecting the occurrence of the one or more events and in accordance with a determination that the one or more events does not include the second event, forgoes display, via the second display generation component, of the second user interface element (e.g., while continuing to display the first user interface element). Displaying a first user interface element based on movement of a computer system that is at least partially circumscribed by a second user interface element displayed based on occurrence of events provides information that traditionally required several user inputs, which reduces the number of inputs needed to perform an operation.

In some embodiments, the first event is detected based on current directional movement of the computer system (e.g., moving of the computer system in a direction (e.g., in respect to the direction that computer system is facing, in some embodiments)), and wherein the second event is not detected based on current directional movement of the computer system. Assigning different events to different display generation components allows a user to know where to look for particular information about the state of a computer system, reducing the number of inputs needed to perform an operation.

In some embodiments, the computer system: while displaying the first user interface element with the second appearance and the second user interface element, detects an occurrence of a first set of one or more events; and in response to detecting the occurrence of the first set of one or more events: in accordance with a determination that the first set of one or more events includes the first event and the second event, modifies, via the first display generation component, display of the first user interface element and modifying, via the second display generation component, display of the second user interface element; in accordance with a determination that the first set of one or more events includes the first event but does not include the second event, modifies, via the first display generation component, display of the first user interface element without modifying, via the second display generation component, display of the second user interface element; and in accordance with a determination that the first set of one or more events includes the second event but does not include the first event, modifies, via the second display generation component, display of the second user interface element without modifying, via the first display generation component, display of the first user interface element; and in accordance with a determination that the first set of one or more events does not include the first event and the second event, forgoes modifying, via the first display generation component and forgoing modifying, via the second display generation component, display of the second user interface element without modifying, via the first display generation component, display of the first user interface element. In some embodiments, while displaying the first user interface element with the first appearance and the second user interface element, the computer system detects an occurrence of a third one or more events. In some embodiments, in response to detecting the occurrence of the third one or more events, the computer system: in accordance with a determination that the third one or more events does not include the first event and includes the second event, modifies, via the first display generation component, display of the first user interface element without modifying, via the second display generation component, display of the second user interface element; in accordance with a determination that the third one or more events includes the first event but does not include the second event, the computer system forgoes modifying, via the first display generation component, display of the first user interface element and forgoes modifying, via the second display generation component, display of the second user interface element; in accordance with a determination that the third one or more events does not include the first event and the second event, the computer system modifies, via the first display generation component, the first user interface element without modifying, via the second display generation component, display of the second user interface element; and in accordance with a determination that the third one or more events includes the first event and the second event, the computer system modifies, via the second display generation component, display of the second user interface element and modifies, via the first display generation component, display of the first user interface element. Updating different user interface elements based on particular events occurring allows a user to be up to date on what is happening with the computer system without needing to navigate to different user interfaces, reducing the number of inputs needed to perform an operation.

In some embodiments, displaying the second user interface element includes pulsating visual characteristics of the second user interface element, and wherein displaying the first user interface element does not include pulsating one or more visual characteristics of the first user interface element. Pulsating some even information and not other information allows a user to focus on important events without being lost in too many, reducing the number of inputs needed to perform an operation.

In some embodiments, the second user interface element includes an indication of a change (e.g., future change and/or a current change) in orientation of the computer system (e.g., signal information) (e.g., signal for directions related to turning, rotating, and/or moving). Indicating a change in orientation of the computer system allows for a user and other users to understand how the computer system is interacting with an environment, providing improved visual feedback to the user and performing an operation when a set of conditions has been met without requiring further user input.

In some embodiments, in accordance with a determination that the second event corresponds to an event that corresponds to a first direction (e.g., a slide left, a slide right, a clockwise rotation, a right turn, a counterclockwise rotation, and/or a left turn), the second display generation component is a third display generation component; and in accordance with a determination that the second event corresponds to an event that corresponds to a second direction that is different from the first direction, the second display generation component is a fourth display generation component that is different from the third display generation component. Providing different display generation components to display information about different direction-based events allows for a user to be able to identify where to look for particular information, providing improved visual feedback to the user and performing an operation when a set of conditions has been met without requiring further user input.

In some embodiments, the second user interface element includes hazard information. In some embodiments, while the second user interface element is displayed via the display generation, the second display generation component an identical user interface element is displayed via a display generation component that is different from the second display generation component (e.g., while the displaying hazard information). However, while displaying signal information, the display generation components do not have the same information displayed and/or user interface elements displayed on both display generation components. Including hazard information in the second user interface element provides information that is typically not so readily available, reducing the number of inputs needed to perform an operation.

In some embodiments, the first user interface element displayed with the second appearance includes information concerning one or more subjects detected in an environment, and wherein the first user interface element displayed with the first appearance does not include information concerning one or more subjects detected in the environment (e.g., as described above in relation to the user interface element and/or representation of the subject and method 700). Displaying information concerning subjects detected in an environment provides a user with a better understanding of what is going on around the computer system and what is being detected by the computer system, providing improved visual feedback to the user and performing an operation when a set of conditions has been met without requiring further user input.

In some embodiments, the first user interface element displayed with the second appearance indicates that the computer system will not be moving within a predetermined period of time (e.g., as described above in relation to and method 700), and wherein the first user interface element indicates that the computer system will be moving within the predetermined period of time (e.g., as described above in relation to and method 700). Providing an indication ahead of time when the computer system will be moving allows for others to understand future movements of the computer system, providing improved visual feedback to the user and performing an operation when a set of conditions has been met without requiring further user input.

In some embodiments, the first user interface element displayed with the first appearance has a first amount of a visual characteristic (e.g., as described above in relation to and method 700), and wherein the first user interface element displayed with the second appearance has a second amount of the visual characteristic (e.g., as described above in relation to and method 700) that is different from the first amount of the visual characteristic. Variable amounts of the visual characteristic allow for a user to quickly understand the state of the computer system without needing to rummage through different user interfaces, reducing the number of inputs needed to perform an operation.

In some embodiments, the second display generation component is different type of display generation component than the first display generation component. In some embodiments, the second display generation component is the same type of display generation component than the first display generation component. In some embodiments, the second display generation component is the first display generation component. Providing different types of display generation components allows for a system to take advantage of things that particular types of display generation components do better, providing improved visual feedback to the user and performing an operation when a set of conditions has been met without requiring further user input.

In some embodiments, an output of the second display generation component at least partially circumscribes (e.g., encircles the perimeter of and/or surrounds) an output of the first display generation component. In some embodiments, light output from the second display generation component is directed in a direction that results in an appearance to at least partially circumscribe light output from the first display generation component. In some embodiments, light output from the second display generation component is in a different direction than light output from the first display generation component. In some embodiments, the second display component at least partially circumscribes the first display generation component. Ensuring output of the second display generation component at least partially circumscribes an output of the first display generation component allows for a more succinct expression of a state of the computer system, providing improved visual feedback to the user and performing an operation when a set of conditions has been met without requiring further user input.

In some embodiments, a display area (e.g., a display surface that light from the first display generation component is directed) that corresponds to the first display generation component protrudes further out (e.g., in a particular direction) from the computer system than a display area (e.g., a display surface that light from the second display generation component is directed) that corresponds to the second display generation component. In some embodiments, the display area for the first display generation component is parallel to the display area for the second display generation component. Protruding parts of a display area allows for different display generation components to take advantage of different topologies, providing improved visual feedback to the user and performing an operation when a set of conditions has been met without requiring further user input.

In some embodiments, the second user interface element is displayed using mostly indirect light (e.g., displaying using light that reflects off a surface) and the first user interface element is not displayed using mostly indirect light (e.g., displayed using light that does not reflect off a surface). In some embodiments, a resolution output by the second display generation component is different from (e.g., more or less) a resolution output by the first display generation component. In some embodiments, there is a gap between the second user interface element and the first user interface element. In some embodiments, there is a gap between a display area for the second display generation component and a display area for the first display generation component. Using indirect light allows for certain optical advantages to take place for particular representations, providing improved visual feedback to the user and performing an operation when a set of conditions has been met without requiring further user input.

Note that details of the processes described above with respect to method 1200 (e.g., FIG. 12) are also applicable in an analogous manner to the methods described above and below. For example, method 700 optionally includes one or more of the characteristics of the various methods described above with reference to method 1200. For example, the first user interface element of method 1200 can displayed via the respective user interface of method 700. For brevity, these details are not repeated.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve an indication of movement. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine what to display. Accordingly, use of such personal information data enables users to have calculated control of what is displayed. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of display services, the present technology can be configured to allow users to select to “opt in” or “opt out” of participation in the collection of personal information data during registration for services or anytime thereafter. In another example, users can select not to provide data for targeted services. In yet another example, users can select to limit the length of time data is maintained or entirely prohibit the development of a baseline profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed by inferring preferences based on non-personal information data or a bare minimum amount of personal information, such as the content being requested by the device associated with a user, other non-personal information available to the services, or publicly available information.

What is claimed is:

1-25. (canceled)

26. A method, comprising:
at a computer system that is in communication with a display generation component and one or more sensors:
detecting, via the one or more sensors, data corresponding to a subject in an environment; and
in response to detecting the data corresponding to the subject:
in accordance with a determination that the subject meets a respective set of criteria, wherein the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and
in accordance with a determination that the subject does not meet the respective set of criteria, forgoing displaying the first user interface object.

27. The method of claim 26, wherein the respective set of criteria includes a criterion that is met when a determination is made that the subject is within a first area with respect to the computer system and not within a second area with respect to the computer system.

28. The method of claim 26, further comprising:
in response to detecting the data corresponding to the subject:
in accordance with a determination that the subject is within a third area and within a predetermined distance from the computer system, displaying the first user interface object; and
in accordance with a determination that the subject is within the third area and not within a predetermined distance from the computer system, forgoing displaying the first user interface object.

29. The method of claim 26, wherein the first user interface object is displayed with an indication that the computer system is not moving.

30. The method of claim 26, wherein displaying the first user interface object includes:
in accordance with a determination that the subject is moving in a first direction in the environment, moving the first user interface object in a second direction; and
in accordance with a determination that the subject is moving in a third direction in the environment, moving the first user interface object in a fourth direction that is different from the second direction, wherein the third direction is different form the first direction.

31. The method of claim 26, wherein the set of criteria includes a criterion that is met when the subject is a first type of subject, and wherein the set of criteria includes a criterion that is not met when the subject is a second type of subject different from the first type of subject.

32. The method of claim 26, further comprising:
while displaying the first user interface object, detecting, via the one or more sensors, data corresponding to a second subject that is different from the subject; and
in response to data corresponding the second subject:
in accordance with a determination that the subject and the second subject meet the set of criteria, displaying, via the display generation component, a second user interface object that has a visual appearance that is based on the visual appearance of the second subject, wherein the second user interface is displayed concurrently with the first user interface object.

33. The method of claim 26, wherein:
while displaying the first user interface object and the second user interface object:
in accordance with a determination that the subject and the second subject meet the set of criteria and in accordance with a determination that the subject is closer to the computer system than the second subject, displaying the first user interface element at least partially on top of the second user interface object; and
in accordance with a determination that the subject and the second subject meet the set of criteria and in accordance with a determination that the second subject is closer to the computer system than the subject, displaying the second user interface element at least partially on top of the user interface object.

34. The method of claim 26, wherein the first user interface object is displayed with a respective visual characteristic, and the second user interface object is displayed with the respective visual characteristic.

35. The method of claim 26, further comprising:
while displaying the first user interface object and the second user interface object, detecting movement of one or more of the subject and the second subject; and
in response to detecting movement of one or more of the subject and the second subject:
in accordance with a determination that the subject is within a third area relative to the computer system and the second subject is within a fourth area relative to the computer system, wherein the fourth area is different form the third area, and wherein the fourth area and the third area are within the predetermined distance from the computer system, continuing to display the first user interface object without displaying the second user interface object; and
in accordance with a determination that the second subject is within the third area relative to the computer system and the subject within the fourth area relative to the computer system, continuing to display the second user interface object without displaying the first user interface object.

36-39. (canceled)

40. A non-transitory computer-readable storage medium storing one or more programs configured to be executed by one or more processors of a computer system that is in communication with a display generation component and one or more sensors, the one or more programs including instructions for:
detecting, via the one or more sensors, data corresponding to a subject in an environment; and
in response to detecting the data corresponding to the subject:
in accordance with a determination that the subject meets a respective set of criteria, wherein the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and
in accordance with a determination that the subject does not meet the respective set of criteria, forgoing displaying the first user interface object.

41. A computer system configured to communicate with a display generation component and one or more sensors, comprising:
one or more processors; and
memory storing one or more programs configured to be executed by the one or more processors, the one or more programs including instructions for:
detecting, via the one or more sensors, data corresponding to a subject in an environment; and
in response to detecting the data corresponding to the subject:
in accordance with a determination that the subject meets a respective set of criteria, wherein the respective set of criteria includes a criterion that is met when a determination is made that the subject is within a predetermined distance from the computer system, displaying, via the display generation component, a user interface that indicates awareness of the subject, including a first user interface object that has a visual appearance that is based on the visual appearance of the subject; and
in accordance with a determination that the subject does not meet the respective set of criteria, forgoing displaying the first user interface object.

42-125. (canceled)
